(19) United States
(12) Patent Application Publication
(10) Pub. No.: US 2026/0160850 A1
(43) Pub. Date: Jun. 11, 2026

(54) POSITIONING WITH ENHANCED ANTENNA CAPABILITY

(71) Applicant: QUALCOMM Incorporated, San Diego, CA (US)

(72) Inventors: Avinash SHRIVASTAVA, Hyderabad (IN); Arun Kumar Sharma TANDRA, Hyderabad (IN)

(21) Appl. No.: 18/970,120

(22) Filed: Dec. 5, 2024

(51) Int. Cl. G01S 5/02; H04W 64/00

(52) U.S. Cl. CPC G01S 5/0236; G01S 5/0244; H04W 64/00; G01S 2205/008

(57) ABSTRACT

Disclosed are techniques for wireless communication. In an aspect, a wireless device may receive configuration information for a positioning process of the wireless device, wherein the positioning process uses a selected Wireless Wide Area Network (WWAN) antenna module type of a plurality of WWAN antenna module types each supporting a Radio Access Technology (RAT) and one or more frequency ranges, wherein the selected antenna module type is selected based on the supported RAT, one or more frequency ranges, or a combination thereof, and further selected based on one or more parameters, the one or more parameters including one or more signal propagation parameters, one or more signal quality parameters, one or more positioning quality parameters, one or more use case parameters, or a combination thereof, and perform one or more positioning operations of the positioning process using an antenna module having the selected WWAN antenna module type.

### TECHNICAL FIELD

Aspects of the disclosure relate generally to wireless technologies.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), Radiofrequency (RF) sensing, and other technical enhancements. These enhancements, as well as the use of higher frequency bands, enable improved RF sensing and 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of positioning performed by a wireless device including a plurality of antenna modules includes receiving configuration information for a positioning process of the wireless device, wherein the positioning process uses a selected Wireless Wide Area Network (WWAN) antenna module type of a plurality of WWAN antenna module types each supporting a Radio Access Technology (RAT) and one or more frequency ranges, wherein the selected WWAN antenna module type is selected based on the supported RAT, one or more frequency ranges, or a combination thereof, and further selected based on one or more parameters, the one or more parameters including one or more signal propagation parameters, one or more signal quality parameters, one or more positioning quality parameters, one or more use case parameters, or a combination thereof; and performing one or more positioning operations of the positioning process using an antenna module having the selected WWAN antenna module type.

In an aspect, a method performed at a location server includes receiving an indication of at least a plurality of Wireless Wide Area Network (WWAN) antenna module types included in a wireless device and an indication of one or more parameters, wherein each of the plurality of WWAN antenna module types supports a Radio Access Technology (RAT) and one or more frequency ranges, and wherein the one or more parameters include one or more signal propagation parameters, one or more signal quality parameters, one or more positioning quality parameters, one or more use case parameters, or a combination thereof for antenna module selection; and transmitting configuration information according to a Long Term Evolution Positioning Protocol (LPP) or New Radio Positioning Protocol (NRPP) for a positioning process of the wireless device using a selected WWAN antenna module type of the plurality of WWAN antenna module types, wherein the selected WWAN antenna module type is selected based on the supported RAT, one or more frequency ranges, or a combination thereof, and further selected based on at least one of the one or more parameters.

In an aspect, a wireless device includes one or more memories; one or more transceivers; a plurality of antenna modules; and one or more processors communicatively coupled to the one or more memories and the one or more transceivers, the one or more processors, either alone or in combination, being configured to: receive, via the one or more transceivers, configuration information for a positioning process of the wireless device, wherein the positioning process uses a selected Wireless Wide Area Network (WWAN) antenna module type of a plurality of WWAN antenna module types each supporting a Radio Access Technology (RAT) and one or more frequency ranges, wherein the selected WWAN antenna module type is selected based on the supported RAT, one or more frequency ranges, or a combination thereof, and further selected based on one or more parameters, the one or more parameters including one or more signal propagation parameters, one or more signal quality parameters, one or more positioning quality parameters, one or more use case parameters, or a combination thereof; and perform one or more positioning operations of the positioning process using an antenna module having the selected WWAN antenna module type.

In an aspect, a location server includes one or more memories; one or more transceivers; and one or more processors communicatively coupled to the one or more memories and the one or more transceivers, the one or more processors, either alone or in combination, being configured to: receive, via the one or more transceivers, an indication of at least a plurality of Wireless Wide Area Network (WWAN) antenna module types included in a wireless device and an indication of one or more parameters, wherein each of the plurality of WWAN antenna module types supports a Radio Access Technology (RAT) and one or more frequency ranges, and wherein the one or more parameters include one or more signal propagation parameters, one or more signal quality parameters, one or more positioning quality parameters, one or more use case parameters, or a combination thereof for antenna module selection; and transmit, via the one or more transceivers and according to a Long Term Evolution Positioning Protocol (LPP) or New Radio Positioning Protocol (NRPP), configuration information for a positioning process of the wireless device using a selected WWAN antenna module type of the plurality of WWAN antenna module types, wherein the selected WWAN antenna module type is selected based on the supported RAT, one or more frequency ranges, or a combination thereof, and further selected based on at least one of the one or more parameters.

In an aspect, a wireless device includes means for receiving configuration information for a positioning process of the wireless device, wherein the positioning process uses a selected Wireless Wide Area Network (WWAN) antenna module type of a plurality of WWAN antenna module types each supporting a Radio Access Technology (RAT) and one or more frequency ranges, wherein the selected WWAN antenna module type is selected based on the supported RAT, one or more frequency ranges, or a combination thereof, and further selected based on one or more parameters, the one or more parameters including one or more signal propagation parameters, one or more signal quality parameters, one or more positioning quality parameters, one or more use case parameters, or a combination thereof; and means for performing one or more positioning operations of the positioning process using an antenna module having the selected WWAN antenna module type.

In an aspect, a location server includes means for receiving an indication of at least a plurality of Wireless Wide Area Network (WWAN) antenna module types included in a wireless device and an indication of one or more parameters, wherein each of the plurality of WWAN antenna module types supports a Radio Access Technology (RAT) and one or more frequency ranges, and wherein the one or more parameters include one or more signal propagation parameters, one or more signal quality parameters, one or more positioning quality parameters, one or more use case parameters, or a combination thereof for antenna module selection; and means for transmitting configuration information according to a Long Term Evolution Positioning Protocol (LPP) or New Radio Positioning Protocol (NRPP) for a positioning process of the wireless device using a selected WWAN antenna module type of the plurality of WWAN antenna module types, wherein the selected WWAN antenna module type is selected based on the supported RAT, one or more frequency ranges, or a combination thereof, and further selected based on at least one of the one or more parameters.

In an aspect, a non-transitory computer-readable medium stores computer-executable instructions that, when executed by a wireless device, cause the wireless device to: receive configuration information for a positioning process of the wireless device, wherein the positioning process uses a selected Wireless Wide Area Network (WWAN) antenna module type of a plurality of WWAN antenna module types each supporting a Radio Access Technology (RAT) and one or more frequency ranges, wherein the selected WWAN antenna module type is selected based on the supported RAT, one or more frequency ranges, or a combination thereof, and further selected based on one or more parameters, the one or more parameters including one or more signal propagation parameters, one or more signal quality parameters, one or more positioning quality parameters, one or more use case parameters, or a combination thereof; and perform one or more positioning operations of the positioning process using an antenna module having the selected WWAN antenna module type.

In an aspect, a non-transitory computer-readable medium stores computer-executable instructions that, when executed by a location server, cause the location server to: receive an indication of at least a plurality of Wireless Wide Area Network (WWAN) antenna module types included in a wireless device and an indication of one or more parameters, wherein each of the plurality of WWAN antenna module types supports a Radio Access Technology (RAT) and one or more frequency ranges, and wherein the one or more parameters include one or more signal propagation parameters, one or more signal quality parameters, one or more positioning quality parameters, one or more use case parameters, or a combination thereof for antenna module selection; and transmit configuration information according to a Long Term Evolution Positioning Protocol (LPP) or New Radio Positioning Protocol (NRPP) for a positioning process of the wireless device using a selected WWAN antenna module type of the plurality of WWAN antenna module types, wherein the selected WWAN antenna module type is selected based on the supported RAT, one or more frequency ranges, or a combination thereof, and further selected based on at least one of the one or more parameters.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 illustrates examples of various positioning methods supported in New Radio (NR), according to aspects of the disclosure.

FIG. 5 illustrates example Long-Term Evolution (LTE) positioning protocol (LPP) reference sources for positioning.

FIG. 6 is a diagram illustrating an example round-trip-time (RTT) procedure for determining a location of a UE, according to aspects of the disclosure.

FIG. 7 is a diagram showing example timings of RTT measurement signals exchanged between a base station and a UE, according to aspects of the disclosure.

FIG. 8 is a diagram illustrating example timings of RTT measurement signals exchanged between a base station and a UE, according to aspects of the disclosure.

FIG. 9 is a diagram illustrating an example base station in communication with an example UE, according to aspects of the disclosure.

FIG. 10 illustrates an example configuration for a wireless device, according to aspects of the disclosure.

FIG. 11 illustrates an example process to enable positioning based on available antenna module types supporting one or more Wireless Wide Area Network (WWAN) Radiofrequency (RF) technologies, according to aspects of the disclosure.

FIGS. 12A and 12B illustrate Angle of Arrival/Round-Trip-Time (AoA/RTT) positioning, according to some aspects of the disclosure.

FIG. 13 illustrates shows an example configuration for a wireless device with dual Subscriber Identity Module (SIM) capability, according to some aspects of the disclosure.

FIG. 14 illustrates an example Radio Access Network (RAN) sharing system, according to aspects of the disclosure.

FIG. 15 illustrates shows a configuration of a positioning group including a wireless device designated as a leader device, according to aspects of the disclosure.

FIG. 16 illustrates a configuration in which a wireless device performs concurrent WWAN and Global Navigation Satellite System (GNSS) positioning, according to aspects of the disclosure.

FIG. 17 illustrates an example capability exchange between a location server and a wireless device, according to aspects of the disclosure.

FIGS. 18 and 19 illustrate example methods of wireless communication, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to cellular-based positioning using a selected antenna module type of a plurality of antenna module types included in a wireless device. Some aspects more specifically relate to selecting a positioning process using a fifth generation (5G) enabled antenna module supporting Frequency Range 1 (FR1), Frequency Range 2 (FR2); for example, in the context of one or more use cases. In some examples, a cellular-based positioning process using a selected antenna module type that supports a Radio Access Technology (RAT) and one or more associated frequency ranges can be selected, based on recommendation of the wireless device or a location server implementing a Location Management Function (LMF).

Particular aspects of the subject matter described in this disclosure can be implemented to realize one or more of the following potential advantages. In some examples, by providing a mechanism for selecting an antenna module type, the described techniques can be used to support location services and features using advanced positioning techniques. For example, if a wireless device includes one or more antenna modules supporting 5G FR2 positioning processes, centimeter-level positioning may be obtained using emerging positioning techniques such as Angle of Arrival/Round Trip Time (AoA/RTT). Techniques such as AoA/RTT can provide precise positioning based on smaller wavelength, higher bandwidth, availability of massive Multiple Input Multiple Output (MIMO) enabling high quality beamforming. Additionally, in some cases, multiple 5G FR2 antenna modules may be positioned in a wireless device and a particular antenna module can be selected to provide enhanced signal reception capability from all angles.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

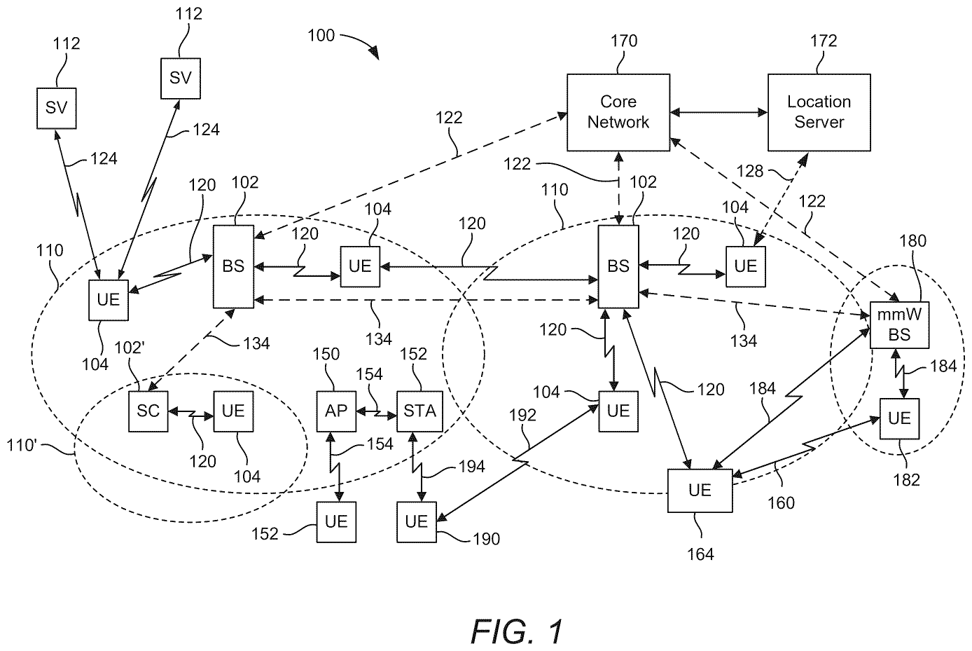

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MULTEFIRE®.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the INTERNATIONAL TELECOMMUNICATION UNION® as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WI-FI DIRECT®, BLUETOOTH®, and so on.

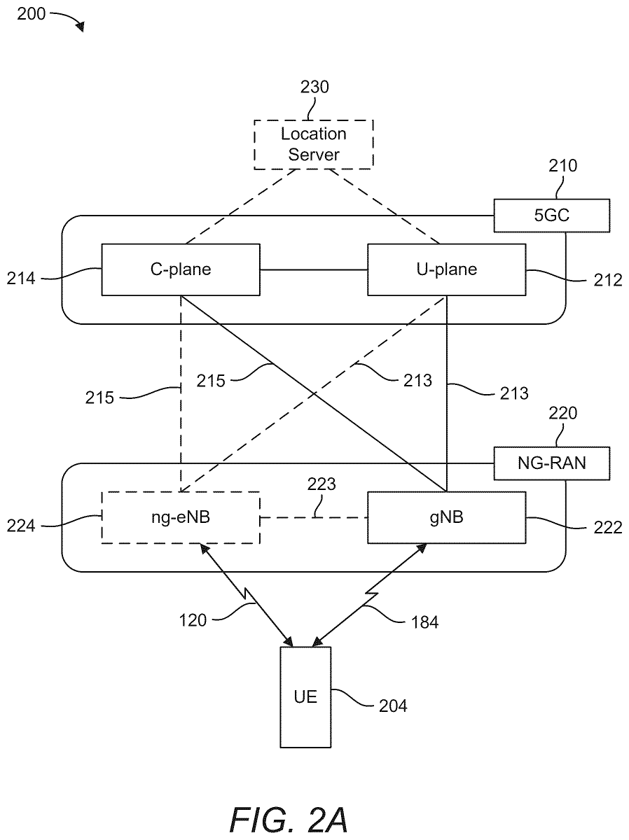

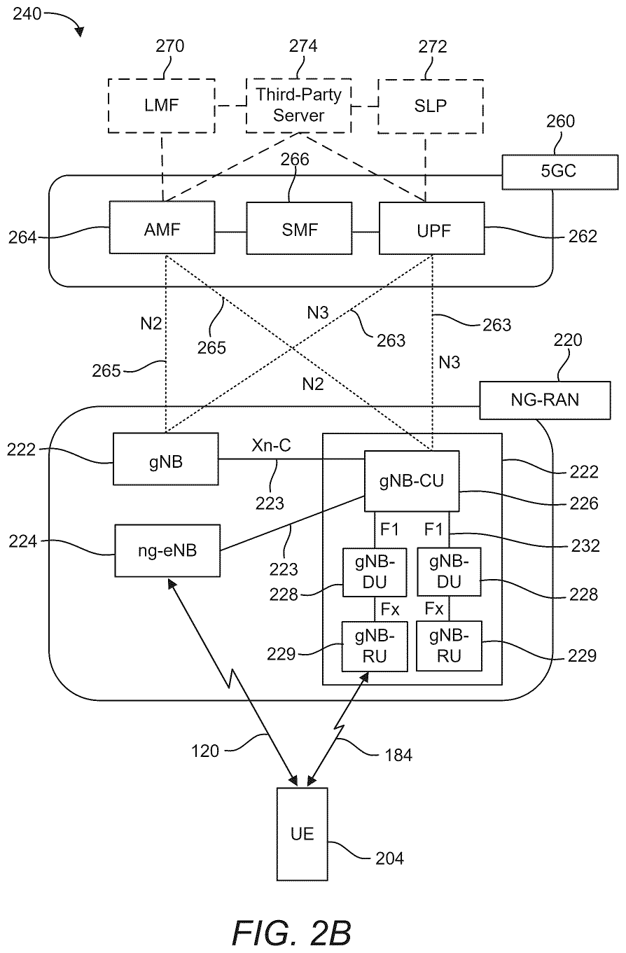

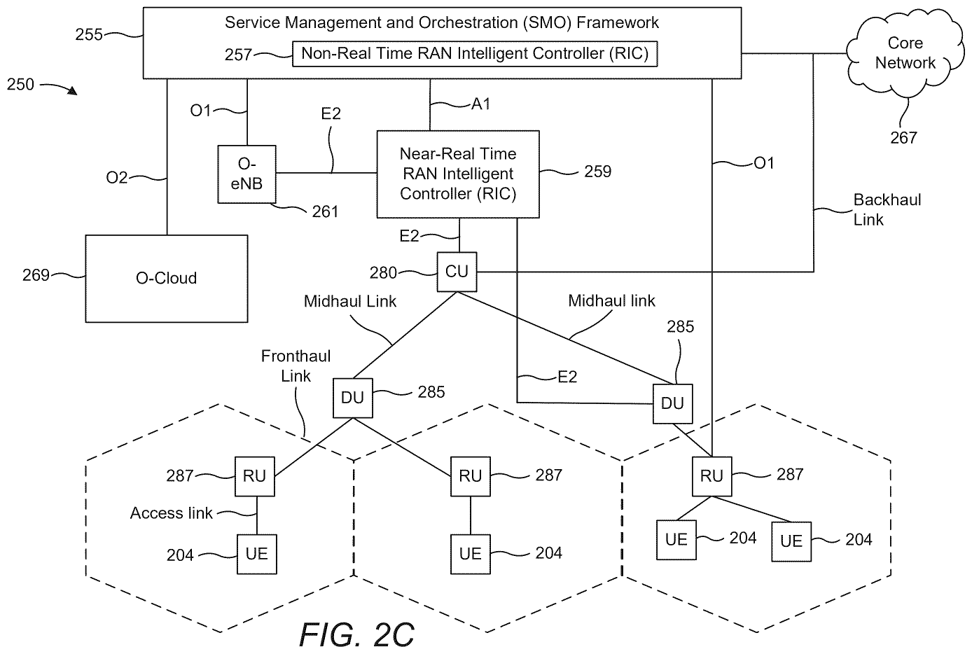

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP® (Third Generation Partnership Project) access networks.

Functions of the UPF 262 include acting as an anchor point for intra/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, AP, TRP, cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN ALLIANCE®)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that can communicate directly with a core network 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more DUs 285 (e.g., gNB-DUs 228) via respective midhaul links, such as an F1 interface. The DUs 285 may communicate with one or more radio units (RUs) 287 (e.g., gNB-RUs 229) via respective fronthaul links. The RUs 287 may communicate with respective UEs 204 via one or more radio frequency (RF) access links. In some implementations, the UE 204 may be simultaneously served by multiple RUs 287.

Each of the units, i.e., the CUs 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a RF transceiver), configured to receive or transmit signals, or both, over a wireless transmission medium to one or more of the other units.

In some aspects, the CU 280 may host one or more higher layer control functions. Such control functions can include RRC, PDCP, service data adaptation protocol (SDAP), or the like. Each control function can be implemented with an interface configured to communicate signals with other control functions hosted by the CU 280. The CU 280 may be configured to handle user plane functionality (i.e., Central Unit—User Plane (CU-UP)), control plane functionality (i.e., Central Unit—Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a RLC layer, a MAC layer, and one or more high PHY layers (such as modules for forward error correction (FEC) encoding and decoding, scrambling, modulation and demodulation, or the like) depending, at least in part, on a functional split, such as those defined by the 3rd Generation Partnership Project (3GPP®). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an O2 interface). Such virtualized network elements can include, but are not limited to, CUs 280, DUs 285, RUs 287 and Near-RT RICs 259. In some implementations, the SMO Framework 255 can communicate with a hardware aspect of a 4G RAN, such as an open eNB (O-eNB) 261, via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, artificial intelligence/machine learning (AI/ML) workflows including model training and updates, or policy-based guidance of applications/features in the Near-RT RIC 259. The Non-RT RIC 257 may be coupled to or communicate with (such as via an A1 interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via 01) or via creation of RAN management policies (such as A1 policies).

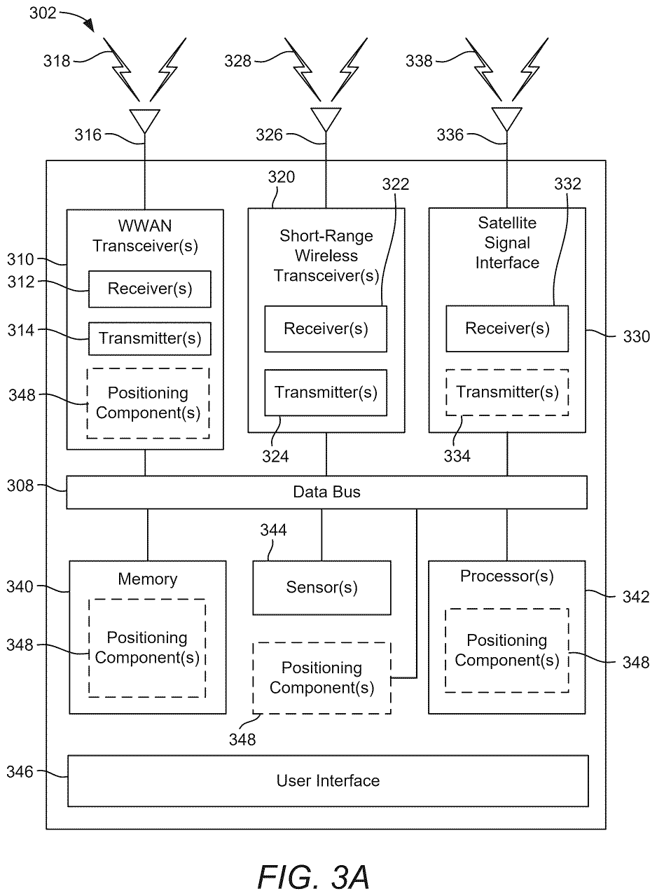

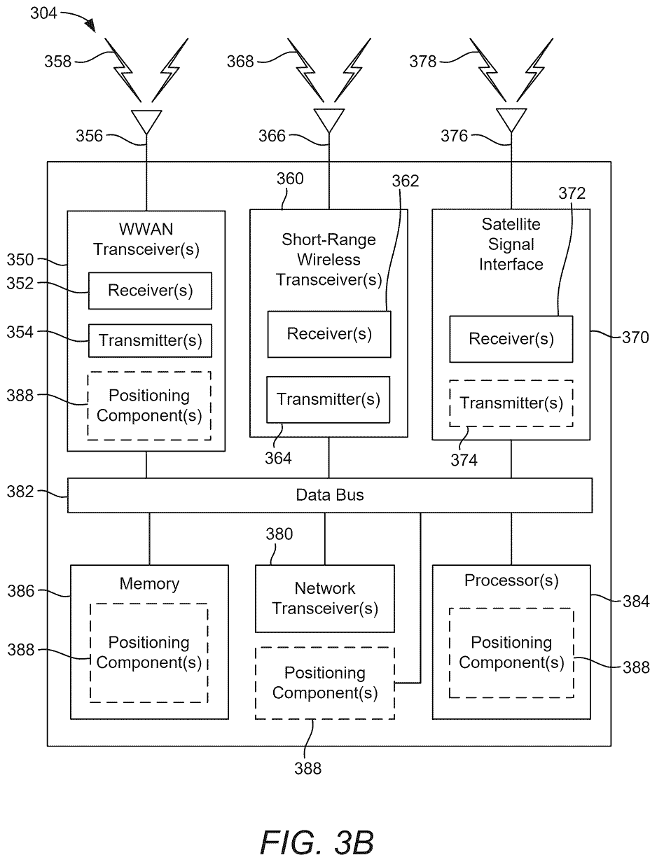

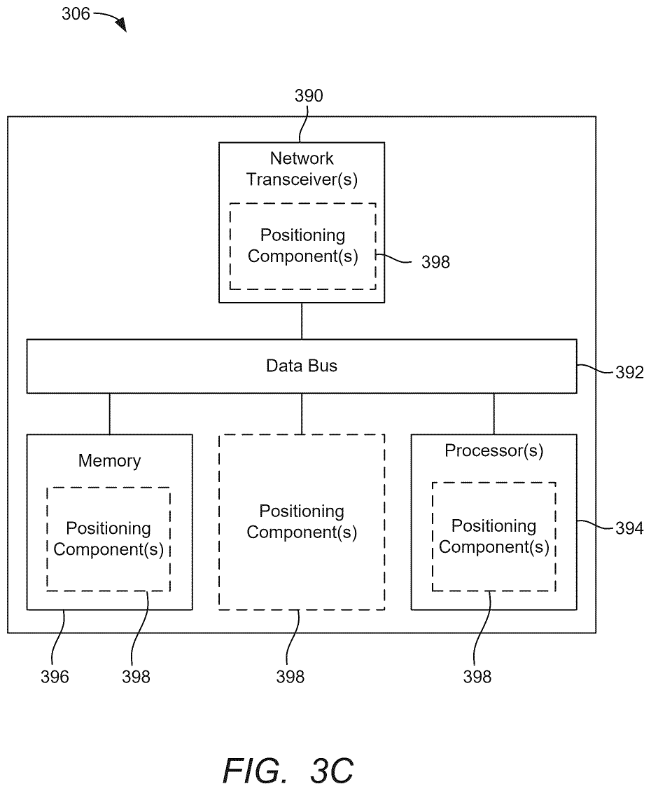

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT/WWAN RF technology (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be Wi-Fi transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal interfaces 330 and 370, which each include one or more satellite signal receivers 332 and 372, respectively, and may optionally include one or more satellite signal transmitters 334 and 374, respectively. In some cases, the base station 304 may be a terrestrial base station that may communicate with space vehicles (e.g., space vehicles 112) via the satellite signal interface 370. In other cases, the base station 304 may be a space vehicle (or other non-terrestrial entity) that uses the satellite signal interface 370 to communicate with terrestrial networks and/or other space vehicles.

The satellite signal receivers 332 and 372 may be connected to one or more antennas 336 and 376, respectively, and may provide means for receiving and/or measuring satellite positioning/communication signals 338 and 378, respectively. Where the satellite signal receiver(s) 332 and 372 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS) signals, etc. Where the satellite signal receiver(s) 332 and 372 are non-terrestrial network (NTN) receivers, the satellite positioning/communication signals 338 and 378 may be communication signals (e.g., carrying control and/or user data) originating from a 5G network. The satellite signal receiver(s) 332 and 372 may comprise any suitable hardware and/or software for receiving and processing satellite positioning/communication signals 338 and 378, respectively. The satellite signal receiver(s) 332 and 372 may request information and operations as appropriate from the other systems, and, at least in some cases, perform calculations to determine locations of the UE 302 and the base station 304, respectively, using measurements obtained by any suitable satellite positioning system algorithm.

The optional satellite signal transmitter(s) 334 and 374, when present, may be connected to the one or more antennas 336 and 376, respectively, and may provide means for transmitting satellite positioning/communication signals 338 and 378, respectively. Where the satellite signal transmitter(s) 374 are satellite positioning system transmitters, the satellite positioning/communication signals 378 may be GPS signals, GLONASS® signals, Galileo signals, Beidou signals, NAVIC, QZSS signals, etc. Where the satellite signal transmitter(s) 334 and 374 are NTN transmitters, the satellite positioning/communication signals 338 and 378 may be communication signals (e.g., carrying control and/or user data) originating from a 5G network. The satellite signal transmitter(s) 334 and 374 may comprise any suitable hardware and/or software for transmitting satellite positioning/communication signals 338 and 378, respectively. The satellite signal transmitter(s) 334 and 374 may request information and operations as appropriate from the other systems.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 342, 384, and 394, respectively, for providing functionality relating to, for example, wireless communication, and for providing other processing functionality. The processors 342, 384, and 394 may therefore provide means for processing, such as means for determining, means for calculating, means for receiving, means for transmitting, means for indicating, etc. In an aspect, the processors 342, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning component(s) 348, 388, and 398, respectively. The positioning component(s) 348, 388, and 398 may be hardware circuits that are part of or coupled to the processors 342, 384, and 394, respectively, that, when executed, cause the UE 302, the base station 304, and the network entity 306 to perform the functionality described herein. In other aspects, the positioning component(s) 348, 388, and 398 may be external to the processors 342, 384, and 394 (e.g., part of a modem processing system, integrated with another processing system, etc.). Alternatively, the positioning component(s) 348, 388, and 398 may be memory modules stored in the memories 340, 386, and 396, respectively, that, when executed by the processors 342, 384, and 394 (or a modem processing system, another processing system, etc.), cause the UE 302, the base station 304, and the network entity 306 to perform the functionality described herein. FIG. 3A illustrates possible locations of the positioning component(s) 348, which may be, for example, part of the one or more WWAN transceivers 310, the memory 340, the one or more processors 342, or any combination thereof, or may be a standalone component. FIG. 3B illustrates possible locations of the positioning component(s) 388, which may be, for example, part of the one or more WWAN transceivers 350, the memory 386, the one or more processors 384, or any combination thereof, or may be a standalone component. FIG. 3C illustrates possible locations of the positioning component(s) 398, which may be, for example, part of the one or more network transceivers 390, the memory 396, the one or more processors 394, or any combination thereof, or may be a standalone component.

The UE 302 may include one or more sensors 344 coupled to the one or more processors 342 to provide means for sensing or detecting movement and/or orientation information that is independent of motion data derived from signals received by the one or more WWAN transceivers 310, the one or more short-range wireless transceivers 320, and/or the satellite signal interface 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 342. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 342, which implements Layer-3 (L3) and Layer-2 (L2) functionality.

In the downlink, the one or more processors 342 provides demultiplexing between transport and logical channels, packet reassembly, deciphering, header decompression, and control signal processing to recover IP packets from the core network. The one or more processors 342 are also responsible for error detection.

Similar to the functionality described in connection with the downlink transmission by the base station 304, the one or more processors 342 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or personal computer (PC) or laptop may have Wi-Fi and/or BLUETOOTH® capability without cellular capability), or may omit the short-range wireless transceiver(s) 320 (e.g., cellular-only, etc.), or may omit the satellite signal interface 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal interface 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 308, 382, and 392, respectively. In an aspect, the data buses 308, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 308, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 342, 384, 394, the transceivers 310, 320, 350, and 360, the memories 340, 386, and 396, the positioning component(s) 348, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as Wi-Fi).

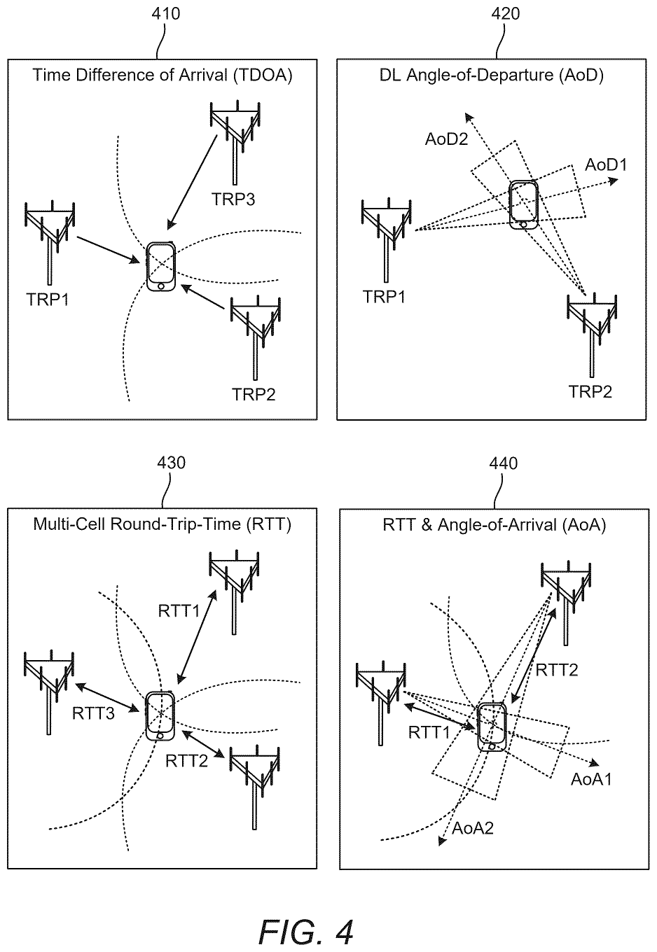

NR supports a number of cellular network-based positioning technologies, including downlink-based, uplink-based, and downlink-and-uplink-based positioning methods. Downlink-based positioning methods include observed time difference of arrival (OTDOA) in LTE, downlink time difference of arrival (DL-TDOA) in NR, and downlink angle-of-departure (DL-AoD) in NR. FIG. 4 illustrates examples of various positioning methods, according to aspects of the disclosure. In an OTDOA or DL-TDOA positioning procedure, illustrated by scenario 410, a UE measures the differences between the times of arrival (ToAs) of reference signals (e.g., positioning reference signals (PRS)) received from pairs of base stations, referred to as reference signal time difference (RSTD) or time difference of arrival (TDOA) measurements, and reports them to a positioning entity. More specifically, the UE receives the identifiers (IDs) of a reference base station (e.g., a serving base station) and multiple non-reference base stations in assistance data. The UE then measures the RSTD between the reference base station and each of the non-reference base stations. Based on the known locations of the involved base stations and the RSTD measurements, the positioning entity (e.g., the UE for UE-based positioning or a location server for UE-assisted positioning) can estimate the UE's location.

For DL-AoD positioning, illustrated by scenario 420, the positioning entity uses a measurement report from the UE of received signal strength measurements of multiple downlink transmit beams to determine the angle(s) between the UE and the transmitting base station(s). The positioning entity can then estimate the location of the UE based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., sounding reference signals (SRS)) transmitted by the UE to multiple base stations. Specifically, a UE transmits one or more uplink reference signals that are measured by a reference base station and a plurality of non-reference base stations. Each base station then reports the reception time (referred to as the relative time of arrival (RTOA)) of the reference signal(s) to a positioning entity (e.g., a location server) that knows the locations and relative timing of the involved base stations. Based on the reception-to-reception (Rx-Rx) time difference between the reported RTOA of the reference base station and the reported RTOA of each non-reference base station, the known locations of the base stations, and their known timing offsets, the positioning entity can estimate the location of the UE using TDOA.

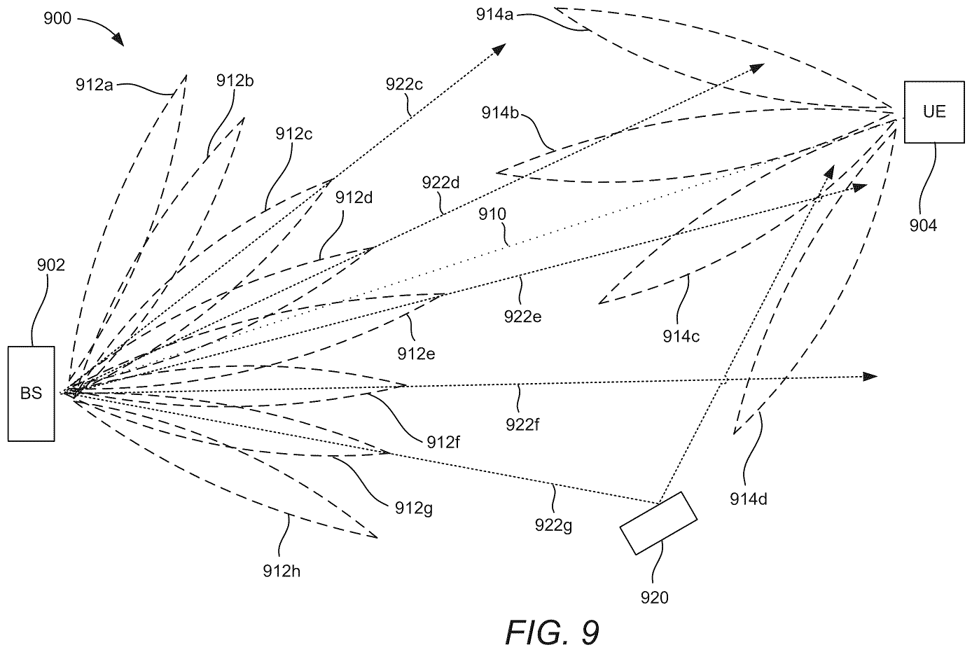

For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE. Example implementations of DL-AoD and UL-AoA techniques are described more fully in FIG. 9 and the associated description.

Downlink-and-uplink-based positioning methods include enhanced cell-ID (E-CID) positioning and multi-round-trip-time (RTT) positioning (also referred to as “multi-cell RTT” and “multi-RTT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the time of arrival (ToA) of the received RTT-related signal and the transmission time of the transmitted RTT-related signal. This time difference is referred to as a reception-to-transmission (Rx-Tx) time difference. The Rx-Tx time difference measurement may be made, or may be adjusted, to include only a time difference between nearest slot boundaries for the received and transmitted signals. Both entities may then send their Rx-Tx time difference measurement to a location server (e.g., an LMF 270), which calculates the round trip propagation time (i.e., RTT) between the two entities from the two Rx-Tx time difference measurements (e.g., as the sum of the two Rx-Tx time difference measurements).

Alternatively, one entity may send its Rx-Tx time difference measurement to the other entity, which then calculates the RTT. The distance between the two entities can be determined from the RTT and the known signal speed (e.g., the speed of light). For multi-RTT positioning, illustrated by scenario 430, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RTT and multi-RTT methods can be combined with other positioning techniques, such as UL-AoA and DL-AoD, to improve location accuracy, as illustrated by scenario 440.

The E-CID positioning method is based on radio resource management (RRM) measurements. In E-CID, the UE reports the serving cell ID, the timing advance (TA), and the identifiers, estimated timing, and signal strength of detected neighbor base stations. The location of the UE is then estimated based on this information and the known locations of the base station(s).

To assist positioning operations, a location server (e.g., location server 230, LMF 270, SLP 272) may provide assistance data to the UE. For example, the assistance data may include identifiers of the base stations (or the cells/TRPs of the base stations) from which to measure reference signals, the reference signal configuration parameters (e.g., the number of consecutive slots including PRS, periodicity of the consecutive slots including PRS, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). In some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

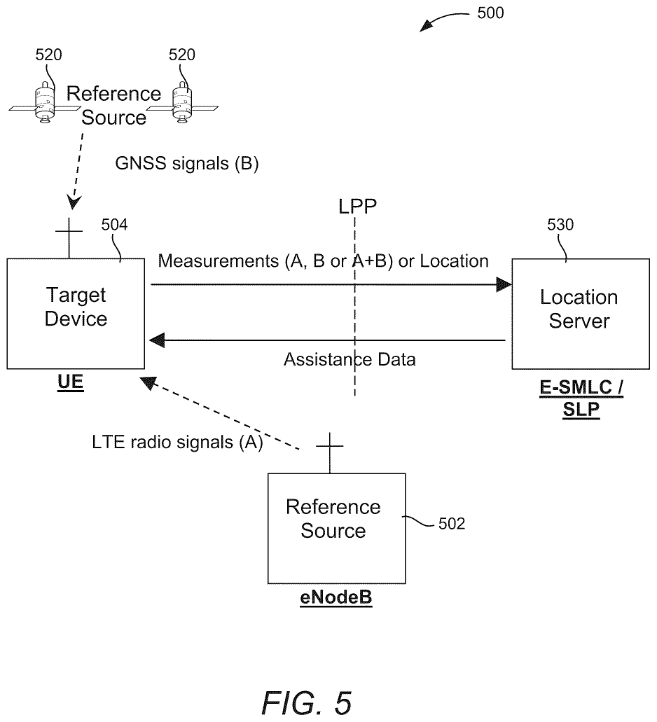

In LTE and, at least in some cases, NR, positioning measurements are reported through higher layer signaling, specifically, LTE positioning protocol (LPP) and/or RRC. LPP is used point-to-point between a location server (e.g., location server 230, LMF 270, SLP 272) and a UE (e.g., any of the UEs described herein) in order to position the UE using location related measurements obtained from one or more reference sources. FIG. 5 is a diagram 500 illustrating example LPP reference sources for positioning. In the example of FIG. 5, a target device, specifically a UE 504 (e.g., any of the UEs described herein), is engaged in an LPP session with a location server 530 (labeled as an “E-SMLC/SLP” in the specific example of FIG. 5). The UE 504 is also receiving/measuring wireless positioning signals from a first reference source, specifically one or more base stations 502 (which may correspond to any of the base stations described herein, and which is labelled as an “eNode B” in the specific example of FIG. 5), and a second reference source, specifically one or more SPS satellites 520 (which may correspond to SVs 112 in FIG. 1).

An LPP session is used between a location server 530 and a UE 504 in order to obtain location-related measurements or a location estimate or to transfer assistance data. A single LPP session is used to support a single location request (e.g., for a single mobile-terminated location request (MT-LR), mobile originated location request (MO-LR), or network induced location request (NI-LR)). Multiple LPP sessions can be used between the same endpoints to support multiple different location requests. Each LPP session comprises one or more LPP transactions, with each LPP transaction performing a single operation (e.g., capability exchange, assistance data transfer, location information transfer). LPP transactions are referred to as LPP procedures. The instigator of an LPP session instigates the first LPP transaction, but subsequent transactions may be instigated by either endpoint. LPP transactions within a session may occur serially or in parallel. LPP transactions are indicated at the LPP protocol level with a transaction identifier in order to associate messages with one another (e.g., request and response). Messages within a transaction are linked by a common transaction identifier.

LPP signaling can be used to request and report measurements related to the following positioning methods: observed time difference of arrival (OTDOA), downlink time difference of arrival (DL-TDOA), assisted global navigation satellite system (A-GNSS), LTE enhanced cell identity (E-CID), NR E-CID, sensor, terrestrial beacon system (TBS), WLAN, Bluetooth, downlink angle of departure (DL-AoD), uplink angle of arrival (UL-AoA), and multi-round-trip-time (RTT). Currently, LPP measurement reports may contain the following measurements: (1) one or more time of arrival (ToA), time difference of arrival (TDOA), reference signal time difference (RSTD), or reception-to-transmission (Rx-Tx) measurements, (2) one or more AoA and/or AoD measurements (currently only for a base station to report UL-AoA and DL-AoD to the location server 530), (3) one or more multipath measurements (per-path ToA, reference signal received power (RSRP), AoA/AoD), (4) one or more motion states (e.g., walking, driving, etc.) and trajectories (currently only for the UE 504), and (5) one or more report quality indications. In the present disclosure, positioning measurements, such as the example measurements just listed, and regardless of the positioning technology, may be referred to collectively as positioning state information (PSI).

The UE 504 and/or the location server 530 may derive location information from one or more reference sources, illustrated in the example of FIG. 5 as SPS satellite(s) 520 and the base station(s) 502. Each reference source can be used to calculate an independent estimate of the location of the UE 504 using associated positioning techniques. In the example of FIG. 5, the UE 504 is measuring characteristics (e.g., ToA, RSRP, RSTD, etc.) of positioning signals received from the base station(s) 502 to calculate, or to assist the location server 530 to calculate, an estimate of the location of the UE 504 using one or more cellular network-based positioning methods (e.g., multi-RTT, OTDOA, DL-TDOA, DL-AoD, E-CID, etc.). Similarly, the UE 504 is measuring characteristics (e.g., ToA) of GNSS signals received from the SPS satellites 520 to triangulate its location in two or three dimensions, depending on the number of SPS satellites 520 measured. In some cases, the UE 504 or the location server 530 may combine the location solutions derived from each of the different positioning techniques to improve the accuracy of the final location estimate.

As noted above, the UE 504 uses LPP to report location related measurements obtained from different reference sources (e.g., base stations 502, Bluetooth beacons, SPS satellites 520, WLAN access points, motion sensors, etc.). As an example, for GNSS-based positioning, the UE 504 uses the LPP information element (IE) “A-GNSS-ProvideLocationInformation” to provide location measurements (e.g., pseudo ranges, location estimate, velocity, etc.) to the location server 530, together with time information. It may also be used to provide a GNSS positioning-specific error reason. The “A-GNSS-ProvideLocationInformation” IE includes IEs such as “GNSS-SignalMeasurementInformation,” “GNSS-LocationInformation,” “GNSS-MeasurementList,” and “GNSS-Error.” The UE 504 includes the “GNSS-LocationInformation” IE when it provides location and optionally velocity information derived using GNSS or hybrid GNSS and other measurements to the location server 530.

The UE 504 uses the “GNSS-SignalMeasurementInformation” IE to provide GNSS signal measurement information to the location server 530 and the GNSS network time association if requested by the location server 530. This information includes the measurements of code phase, Doppler, C/No, and optionally accumulated carrier phase, also referred to as accumulated delta range (ADR), which enable the UE assisted GNSS method where location is computed in the location server 530. The UE 504 uses the “GNSS-MeasurementList” IE to provide measurements of code phase, Doppler, C/No, and optionally accumulated carrier phase (or ADR).

As another example, for motion sensor-based positioning, the currently supported positioning methods use a barometric pressure sensor and a motion sensor. The UE 504 uses the LPP IE “Sensor-ProvideLocationInformation” to provide location information for sensor-based methods to the location server 530. It may also be used to provide a sensor-specific error reason. The UE 504 uses the “Sensor-MeasurementInformation” IE to provide sensor measurements (e.g., barometric readings) to the location server 530.

The UE 504 uses the “Sensor-MotionInformation” to provide movement information to the location server 530. The movement information may comprise an ordered series of points. This information may be obtained by the UE 504 using one or more motion sensors (e.g., accelerometers, barometers, magnetometers, etc.).

As yet another example, for Bluetooth-based positioning, the UE 504 uses the “BT-ProvideLocationInformation” IE to provide measurements of one or more Bluetooth beacons to the location server 530. This IE may also be used to provide Bluetooth positioning specific error reason.

In NR, there may not be precise timing synchronization across the network. Instead, it may be sufficient to have coarse time-synchronization across base stations (e.g., within a cyclic prefix (CP) duration of the orthogonal frequency division multiplexing (OFDM) symbols). RTT-based methods generally only need coarse timing synchronization, and as such, are a preferred positioning method in NR.

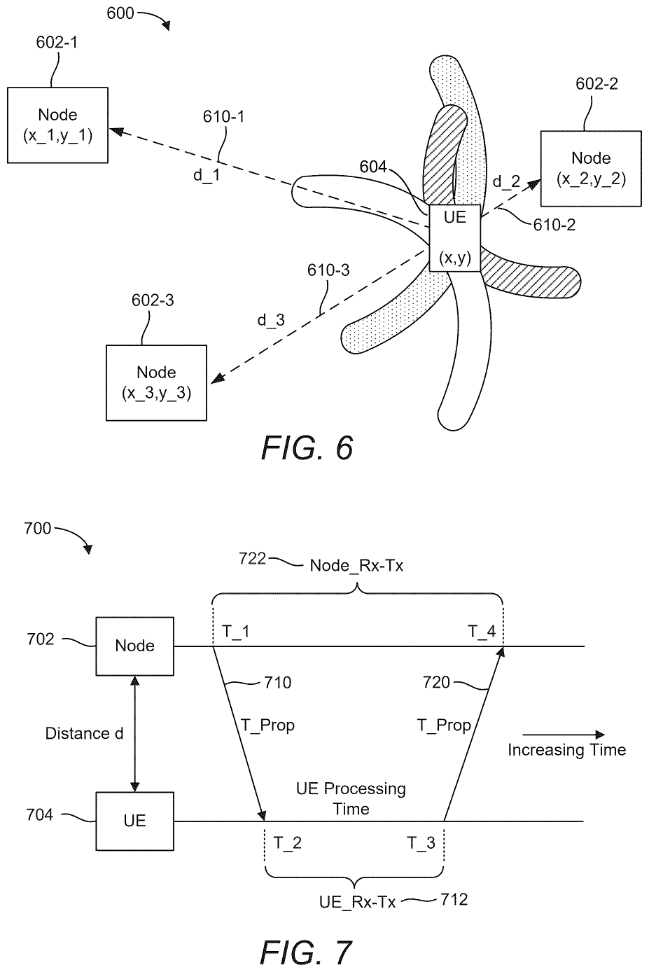

FIG. 6 illustrates an example wireless communications system 600, according to aspects of the disclosure. In the example of FIG. 6, a UE 604 (e.g., any of the UEs described herein) is attempting to calculate an estimate of its location, or assist another entity (e.g., a base station or core network component, another UE, a location server, a third party application, etc.) to calculate an estimate of its location. The UE 604 may transmit and receive wireless signals to and from a plurality of network nodes (labeled “Node”) 602-1, 602-2, and 602-3 (collectively, network nodes 602). The network nodes 602 may include one or more base stations (e.g., any of the base stations described herein), one or more reconfigurable intelligent displays (RIS), one or more positioning beacons, one or more UEs (e.g., connected over sidelinks), etc.

In a network-centric RTT positioning procedure the serving base station (e.g., one of network nodes 602) instructs the UE 604 to measure RTT measurement signals (e.g., PRS) from two or more neighboring network nodes 602 (and typically the serving base station, as at least three network nodes 602 are needed for a two-dimensional location estimate). The involved network nodes 602 transmit RTT measurement signals on low reuse resources (e.g., resources used by the network nodes 602 to transmit system information, where the network nodes 602 are base stations) allocated by the network (e.g., location server 230, LMF 270, SLP 272). The UE 604 records the arrival time (also referred to as the receive time, reception time, time of reception, or time of arrival) of each RTT measurement signal relative to the UE's 604 current downlink timing (e.g., as derived by the UE 604 from a downlink signal received from its serving base station), and transmits a common or individual RTT response signal (e.g., SRS) to the involved network nodes 602 on resources allocated by its serving base station. The UE 604, if it not the positioning entity, reports a UE reception-to-transmission (Rx-Tx) time difference measurement to the positioning entity. The UE Rx-Tx time difference measurement indicates the time difference between the arrival time of each RTT measurement signal at the UE 604 and the transmission time(s) of the RTT response signal(s). Each involved network node 602 also reports, to the positioning entity, a network node Rx-Tx time difference measurement (also referred to as a base station (BS) or gNB Rx-Tx time difference measurement), which indicates the difference between the transmission time of the RTT measurement signal and the reception time of the RTT response signal.

A UE-centric RTT positioning procedure is similar to the network-based procedure, except that the UE 604 transmits uplink RTT measurement signal(s) (e.g., on resources allocated by the serving base station). The uplink RTT measurement signal(s) are measured by multiple network nodes 602 in the neighborhood of the UE 604. Each involved network node 602 responds with a downlink RTT response signal and reports a network node Rx-Tx time difference measurement to the positioning entity. The network node Rx-Tx time difference measurement indicates the time difference between the arrival time of the RTT measurement signal at the network node 602 and the transmission time of the RTT response signal. The UE 604, if it is not the positioning entity, reports, for each network node 602, a UE Rx-Tx time difference measurement that indicates the difference between the transmission time of the RTT measurement signal and the reception time of the RTT response signal.

In order to determine the location (x, y) of the UE 604, the positioning entity needs to know the locations of the network nodes 602, which may be represented in a reference coordinate system as (x_k, y_y), where k=1, 2, 3 in the example of FIG. 6. Where the UE 604 is the positioning entity, a location server with knowledge of the network geometry (e.g., location server 230, LMF 270, SLP 272) may provide the locations of the involved network nodes 602 to the UE 604.

The positioning entity determines each distance 610 (d_k, where k=1, 2, 3) between the UE 604 and the respective network node 602 based on the UE Rx-Tx and network node Rx-Tx time difference measurements and the speed of light, as described further below with reference to FIG. 7. Specifically, in the example of FIG. 6, the distance 610-1 between the UE 604 and the network node 602-1 is d_1, the distance 610-2 between the UE 604 and the network node 602-2 is d_2, and the distance 610-3 between the UE 604 and the network node 602-3 is d_3. Once each distance 610 is determined, the positioning entity can solve for the location (x, y) of the UE 604 by using a variety of known geometric techniques, such as trilateration. From FIG. 6, it can be seen that the location of the UE 604 ideally lies at the common intersection of three semicircles, each semicircle being defined by radius dk and center (x_k, y_k), where k=1, 2, 3.

FIG. 7 is a diagram 700 showing example timings of RTT measurement signals exchanged between a network node 702 (labeled “Node”) and a UE 704, according to aspects of the disclosure. The UE 704 may be any of the UEs described herein. The network node 702 may be a base station (e.g., any of the base stations described herein), an RIS, a positioning beacon, another UE (e.g., connected over a sidelink), or the like.

In the example of FIG. 7, the network node 702 (labeled “BS”) sends an RTT measurement signal 710 (e.g., PRS) to the UE 704 at time T_1. The RTT measurement signal 710 has some propagation delay T_Prop as it travels from the network node 702 to the UE 704. At time T_2 (the reception time of the RTT measurement signal 710 at the UE 704), the UE 704 measures the RTT measurement signal 710. After some UE processing time, the UE 704 transmits an RTT response signal 720 (e.g., SRS) at time T_3. After the propagation delay T_Prop, the network node 702 measures the RTT response signal 720 from the UE 704 at time T_4 (the reception time of the RTT response signal 720 at the network node 702).

The UE 704 reports the difference between time T_3 and time T_2 (i.e., the UE's 704 Rx-Tx time difference measurement, shown as UE_Rx-Tx 712) to the positioning entity. Similarly, the network node 702 reports the difference between time T_4 and time T_1 (i.e., the network node's 702 Rx-Tx time difference measurement, shown as Node_Rx-Tx 722) to the positioning entity. Using these measurements and the known speed of light, the positioning entity can calculate the distance to the UE 704 as d=1/2*c*(Node_Rx−Tx−UE_Rx-Tx)=1/2*c*(T_4−T_1)−1/2*c*(T_3−T_2), where c is the speed of light.

Based on the known location of the network node 702 and the distance between the UE 704 and the network node 702 (and at least two other network nodes 702), the positioning entity can calculate the location of the UE 704. As shown in FIG. 6, the location of the UE 704 lies at the common intersection of three semicircles, each semicircle being defined by a radius of the distance between the UE 704 and a respective network node 702.

In an aspect, the positioning entity may calculate the UE's 604/704 location using a two-dimensional coordinate system; however, the aspects disclosed herein are not so limited, and may also be applicable to determining locations using a three-dimensional coordinate system, if the extra dimension is desired. Additionally, while FIG. 6 illustrates one UE 604 and three network nodes 602 and FIG. 7 illustrates one UE 704 and one network node 702, as will be appreciated, there may be more UEs 604/704 and more network nodes 602/702.

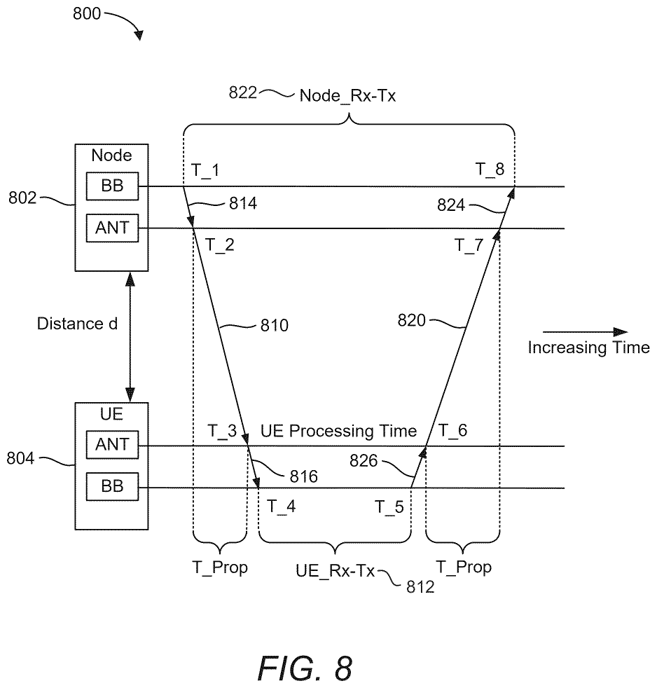

FIG. 8 is a diagram 800 showing example timings of RTT measurement signals exchanged between a network node 802 and a UE 804, according to aspects of the disclosure. The diagram 800 is similar to the diagram 700, except that it includes processing delays that may occur at both the network node 802 (labeled “Node”) and the UE 804 when transmitting and receiving the RTT measurement and response signals. The network node 802 may be a base station (e.g., any of the base stations), a reconfigurable intelligent surface (RIS), another UE (e.g., any of the UEs described herein), or other network node capable of performing an RTT positioning procedure. As a specific example, the network node 802 and the UE 804 may correspond to the base station 702 and the UE 704 in FIG. 7.

Referring now to potential processing delays, at the network node 802, there is a transmission delay 814 between the time T_1 that the network node's 802 baseband (labeled “BB”) generates the RTT measurement signal 810 (e.g., a PRS) and the time T_2 that the network node's 802 antenna(s) (labeled “Ant”) transmit the RTT measurement signal 810. At the UE 804, there is a reception delay 816 between the time T_3 that the UE's 604 antenna(s) (labeled “Ant”) receive the RTT measurement signal 810 and the time T_4 that the UE's 804 baseband (labeled “BB”) processes the RTT measurement signal 810.

Similarly, for the RTT response signal 820 (e.g., an SRS), there is a transmission delay 826 between the time T_5 that the UE's 804 baseband generates the RTT response signal 820 and the time T_6 that the UE's 804 antenna(s) transmit the RTT response signal 820. At the network node 802, there is a reception delay 824 between the time T_7 that the network node's 802 antenna(s) receive the RTT response signal 820 and the time T_8 that the network node's 802 baseband processes the RTT response signal 820.

The difference between times T_2 and T_1 (i.e., transmission delay 814) and times T_8 and T_7 (i.e., reception delay 824) is referred to as the network node's 802 “group delay.” The difference between times T_4 and T_3 (i.e., reception delay 816) and times T_6 and T_5 (i.e., transmission delay 826) is referred to as the UE's 804 “group delay.” The group delay includes a hardware group delay, a group delay attributable to software/firmware, or both. More specifically, although software and/or firmware may contribute to group delay, the group delay is primarily due to internal hardware delays between the baseband and the antenna(s) of the network node 802 and the UE 804.

As shown in FIG. 8, because of the reception delay 816 and the transmission delay 826, the UE's 804 Rx-Tx time difference measurement 812 does not represent the difference between the actual reception time at time T_3 and the actual transmission time at time T_6. Similarly, because of the transmission delay 814 and the reception delay 824, the network node's 802 Rx-Tx time difference measurement 822 does not represent the difference between the actual transmission time at time T_2 and the actual reception time at time T_7. Thus, as shown, group delays, such as reception delays 816 and 824 and transmission delays 814 and 826, can contribute to timing errors and/or calibration errors that can impact RTT measurements, as well as other measurements, such as TDOA, RSTD, etc. This can in turn impact positioning performance. For example, in some designs, a 10 ns error will introduce three meters of error in the final location estimate.

In some cases, the UE 804 can calibrate its group delay and compensate for it so that the UE Rx-Tx time difference measurement 812 reflects the actual reception and transmission times from its antenna(s). Alternatively, the UE 804 can report its group delay to the positioning entity (if not the UE 804), which can then subtract the group delay from the UE Rx-Tx time difference measurement 812 when determining the final distance between the network node 802 and the UE 804. Similarly, the network node 802 may be able to compensate for its group delay in the network node Rx-Tx time difference measurement 822, or simply report the group delay to the positioning entity.

FIG. 9 is a diagram 900 illustrating a base station (BS) 902 (which may correspond to any of the base stations described herein) in communication with a UE 904 (which may correspond to any of the UEs described herein). Referring to FIG. 9, the base station 902 may transmit a beamformed signal to the UE 904 on one or more transmit beams 912a, 912b, 912c, 912d, 912e, 912f, 912g, 912h (collectively, beams 912), each having a beam identifier that can be used by the UE 904 to identify the respective beam. Where the base station 902 is beamforming towards the UE 904 with a single array of antennas (e.g., a single TRP/cell), the base station 902 may perform a “beam sweep” by transmitting first beam 912a, then beam 912b, and so on until lastly transmitting beam 912h. Alternatively, the base station 902 may transmit beams 912 in some pattern, such as beam 912a, then beam 912h, then beam 912b, then beam 912g, and so on. Where the base station 902 is beamforming towards the UE 904 using multiple arrays of antennas (e.g., multiple TRPs/cells), each antenna array may perform a beam sweep of a subset of the beams 912. Alternatively, each of beams 912 may correspond to a single antenna or antenna array.

FIG. 9 further illustrates the paths 922c, 922d, 922e, 922f, and 922g followed by the beamformed signal transmitted on beams 912c, 912d, 912e, 912f, and 912g, respectively. Each path 922c, 922d, 922e, 922f, 922g may correspond to a single “multipath” or, due to the propagation characteristics of radio frequency (RF) signals through the environment, may be comprised of a plurality (a cluster) of “multipaths.” Note that although only the paths 922c-922g for beams 912c-912g are shown, this is for simplicity, and the signal transmitted on each of beams 912 will follow some path. In the example shown, the paths 922c, 922d, 922e, and 922f are straight lines, while path 922g reflects off an obstacle 920 (e.g., a building, vehicle, terrain feature, etc.).

The UE 904 may receive the beamformed signal from the base station 902 on one or more receive beams 914a, 914b, 914c, 914d (collectively, beams 914). Note that for simplicity, the beams illustrated in FIG. 9 represent either transmit beams or receive beams, depending on which of the base station 902 and the UE 904 is transmitting and which is receiving. Thus, the UE 904 may also transmit a beamformed signal to the base station 902 on one or more of the beams 914, and the base station 902 may receive the beamformed signal from the UE 904 on one or more of the beams 912.

In an aspect, the base station 902 and the UE 904 may perform beam training to align the transmit and receive beams of the base station 902 and the UE 904. For example, depending on environmental conditions and other factors, the base station 902 and the UE 904 may determine that the best transmit and receive beams are 912d and 914b, respectively, or beams 912e and 914c, respectively. The direction of the best transmit beam for the base station 902 may or may not be the same as the direction of the best receive beam, and likewise, the direction of the best receive beam for the UE 904 may or may not be the same as the direction of the best transmit beam. Note, however, that aligning the transmit and receive beams is not necessary to perform a downlink angle-of-departure (DL-AoD) or uplink angle-of-arrival (UL-AoA) positioning procedure.

To perform a DL-AoD positioning procedure, the base station 902 may transmit reference signals (e.g., PRS, CRS, TRS, CSI-RS, PSS, SSS, etc.) to the UE 904 on one or more of beams 912, with each beam having a different transmit angle. The different transmit angles of the beams will result in different received signal strengths (e.g., RSRP, RSRQ, SINR, etc.) at the UE 904. Specifically, the received signal strength will be lower for transmit beams 912 that are further from the line of sight (LOS) path 910 between the base station 902 and the UE 904 than for transmit beams 912 that are closer to the LOS path 910.

In the example of FIG. 9, if the base station 902 transmits reference signals to the UE 904 on beams 912c, 912d, 912e, 912f, and 912g, then transmit beam 912e is best aligned with the LOS path 910, while transmit beams 912c, 912d, 912f, and 912g are not. As such, beam 912e is likely to have a higher received signal strength at the UE 904 than beams 912c, 912d, 912f, and 912g. Note that the reference signals transmitted on some beams (e.g., beams 912c and/or 912f) may not reach the UE 904, or energy reaching the UE 904 from these beams may be so low that the energy may not be detectable or at least can be ignored.

The UE 904 can report the received signal strength, and optionally, the associated measurement quality, of each measured transmit beam 912c-912g to the base station 902, or alternatively, the identity of the transmit beam having the highest received signal strength (beam 912e in the example of FIG. 9). Alternatively or additionally, if the UE 904 is also engaged in a round-trip-time (RTT) or time-difference of arrival (TDOA) positioning session with at least one base station 902 or a plurality of base stations 902, respectively, the UE 904 can report reception-to-transmission (Rx-Tx) time difference or reference signal time difference (RSTD) measurements (and optionally the associated measurement qualities), respectively, to the serving base station 902 or other positioning entity. In any case, the positioning entity (e.g., the base station 902, a location server, a third-party client, UE 904, etc.) can estimate the angle from the base station 902 to the UE 904 as the AoD of the transmit beam having the highest received signal strength at the UE 904, here, transmit beam 912e.

In one aspect of DL-AoD-based positioning, where there is only one involved base station 902, the base station 902 and the UE 904 can perform a round-trip-time (RTT) procedure to determine the distance between the base station 902 and the UE 904. Thus, the positioning entity can determine both the direction to the UE 904 (using DL-AoD positioning) and the distance to the UE 904 (using RTT positioning) to estimate the location of the UE 904. Note that the AoD of the transmit beam having the highest received signal strength does not necessarily lie along the LOS path 910, as shown in FIG. 9. However, for DL-AoD-based positioning purposes, it is assumed to do so.

In another aspect of DL-AoD-based positioning, where there are multiple involved base stations 902, each involved base station 902 can report, to the serving base station 902, the determined AoD from the respective base station 902 to the UE 904, or the RSRP measurements. The serving base station 902 may then report the AoDs or RSRP measurements from the other involved base station(s) 912 to the positioning entity (e.g., UE 904 for UE-based positioning or a location server for UE-assisted positioning). With this information, and knowledge of the base stations' 902 geographic locations, the positioning entity can estimate a location of the UE 904 as the intersection of the determined AoDs. There should be at least two involved base stations 902 for a two-dimensional (2D) location solution, but as will be appreciated, the more base stations 902 that are involved in the positioning procedure, the more accurate the estimated location of the UE 904 will be.

To perform an UL-AoA positioning procedure, the UE 904 transmits uplink reference signals (e.g., UL-PRS, SRS, DMRS, etc.) to the base station 902 on one or more of uplink transmit beams 914. The base station 902 receives the uplink reference signals on one or more of uplink receive beams 912. The base station 902 determines the angle of the best receive beams 912 used to receive the one or more reference signals from the UE 904 as the AoA from the UE 904 to itself. Specifically, each of the receive beams 912 will result in a different received signal strength (e.g., RSRP, RSRQ, SINR, etc.) of the one or more reference signals at the base station 902. Further, the channel impulse response of the one or more reference signals will be smaller for receive beams 912 that are further from the actual LOS path 910 between the base station 902 and the UE 904 than for receive beams 912 that are closer to the LOS path 910. Likewise, the received signal strength will be lower for receive beams 912 that are further from the LOS path 910 than for receive beams 912 that are closer to the LOS path 910. As such, the base station 902 identifies the receive beam 912 that results in the highest received signal strength and, optionally, the strongest channel impulse response, and estimates the angle from itself to the UE 904 as the AoA of that receive beam 912. Note that as with DL-AoD-based positioning, the AoA of the receive beam 912 resulting in the highest received signal strength (and strongest channel impulse response if measured) does not necessarily lie along the LOS path 910. However, for UL-AoA-based positioning purposes in FR2, it may be assumed to do so.

Note that while the UE 904 is illustrated as being capable of beamforming, this is not necessary for DL-AoD and UL-AoA positioning procedures. Rather, the UE 904 may receive and transmit on an omni-directional antenna.

Where the UE 904 is estimating its location (i.e., the UE is the positioning entity), it needs to obtain the geographic location of the base station 902. The UE 904 may obtain the location from, for example, the base station 902 itself or a location server (e.g., location server 230, LMF 270, SLP 272). With the knowledge of the distance to the base station 902 (based on the RTT or timing advance), the angle between the base station 902 and the UE 904 (based on the UL-AoA of the best receive beam 912), and the known geographic location of the base station 902, the UE 904 can estimate its location.

Alternatively, where a positioning entity, such as the base station 902 or a location server, is estimating the location of the UE 904, the base station 902 reports the AoA of the receive beam 912 resulting in the highest received signal strength (and optionally strongest channel impulse response) of the reference signals received from the UE 904, or all received signal strengths and channel impulse responses for all receive beams 912 (which allows the positioning entity to determine the best receive beam 912). The base station 902 may additionally report the Rx-Tx time difference to the UE 904. The positioning entity can then estimate the location of the UE 904 based on the UE's 904 distance to the base station 902, the AoA of the identified receive beam 912, and the known geographic location of the base station 902. A combined AoA and RTT location procedure is referred to herein as AoA/RTT positioning.

Antenna technology and implementation is evolving to accommodate emerging applications and performance goals. High precision positioning is an important feature of fifth generation (5G) and future technologies to enable a wide variety of use cases. For example, centimeter level horizontal and vertical accuracy can better enable challenging industrial applications such as robotics and Automated Guided Vehicle (AGV) applications, precision drone/Unmanned Aerial Vehicle (UAV) applications, and mixed reality applications with precise overlay of virtual content over real world content. Enhanced antenna capability for positioning can also enable future systems, such as 5G/6G standalone positioning, in which objects need not be connected to a network to be positioned.

Cellular network-based positioning techniques use Positioning Reference Signals (PRS), Sounding Reference signals (SRS), and/or dedicated carrier phase signals and Angle of Arrival (AoA), Angle of Departure (AoD), Time Difference of Arrival (TDoA), Time of Arrival (TOA), Round Trip Time (RTT), and other measurement techniques. Examples of cellular-based positioning techniques are described above. In some cases, positioning may use cellular-based positioning techniques concurrently with non-cellular positioning techniques; for example, concurrent 5G-GNSS positioning techniques.

One important aspect of the use of 5G NR positioning is the use of higher frequency bands, including frequency bands in the FR2 mmW frequency range that provide wider bandwidth and enable higher data rates. The high frequency FR2 bands enable more accurate positioning by reducing the wavelength of the signal, which allows for more precise measurement of the signal phase and angle of arrival.

5G NR introduces new positioning techniques, such as AoA/RTT, enabling high accuracy positioning with a precision of a few meters or better (e.g, centimeter-level positioning). AoA relies on an array of antennas at the base station to detect the signal and determine its direction, while RTT measures the time it takes for a signal to travel from the mobile device to the base station and back.

5G communications use frequencies that are generally characterized as Frequency Range 1 (FR1) and Frequency Range 2 (FR2). As noted above, FR1 extends from 410 MHz to 7.125 GHz, while FR2 extends from 24.25 GHz to 52.6 GHz, with FR1 also referred to as “Sub-6 GHz” or “sub-6” and FR2 referred to as millimeter wave, “mmWave,” or “mmW.” FR1 and FR2 each include a number of defined frequency bands.

New antenna designs are enabling advanced 5G NR positioning techniques. For example, a Qualcomm® 545 mmWave Antenna Module (QTM545) supports a plurality of frequency bands in the 5G FR2 frequency range, while a Qualcomm® QTM 565 mmWave Antenna Module (QTM565) supports both 5G FR1 and 5G FR2 frequency ranges.

Millimeter wave technology is also being incorporated into Customer Premises Equipment (CPE) devices. Antenna modules for CPE devices may have motorized panels to adjust the antenna arrays; for example, with pre-defined panel positions. Incorporating motorized panels allows the antenna arrays to be adjusted to improve signal reception.

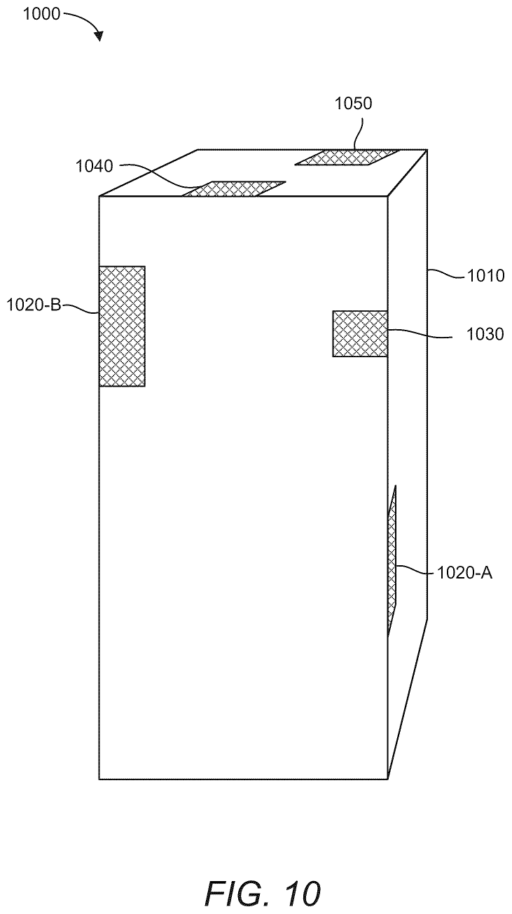

In many cases, a wireless device will incorporate a number of different antenna module types to support different RATs/WWAN RF technologies and different frequency ranges and frequency bands. Further, for efficient radio link management, multiple WWAN antenna modules incorporating antenna arrays and having the same WWAN antenna module type may be positioned at different locations of a user equipment. FIG. 10 shows an example configuration 1000 for a wireless device 1010, with two 5G WWAN antenna modules 1020-A and 1020-B, positioned on two sides of wireless device 1010. Antenna modules 1020-A and 1020-B may transmit/receive signals in the 5G FR1 frequency range, 5G FR2 frequency range, or both; for example, they may be 5G WWAN antenna modules supporting one or more bands included in 5G FR2, one or more bands included in 5G FR1, or both. Additional antenna module types supporting other WWAN RF technologies and/or frequency ranges may be included in wireless device 1010. For an example in which antenna modules 1020-A and 1020-B support one or more frequency bands included in 5G FR2, WWAN antenna module 1030 may support one or more frequency bands included in 5G FR1. Similarly, WWAN antenna module 1040 may support one or more frequency bands included in a 4G frequency range, one or more frequency bands included in a 3G frequency range, etc., while antenna module 1050 may provide satellite positioning capability. Other examples (not shown) include Wi-Fi antenna modules, Bluetooth™ antenna modules, etc. Note that the depictions of the antenna modules in FIG. 10 do not necessarily reflect the positioning, shape, or size of antenna modules and are for illustrative purposes.

For cellular-based positioning, wireless devices such as UEs and CPEs can measure Positioning Reference Signals (PRS) from multiple cells in multiple directions and/or transmit Sounding Reference Signals (SRS) to one or more cells. In some current cases where there are multiple antenna modules having the same antenna module type, PRS reception/SRS transmission may occur with different antenna modules or different motorized panel positions. For the example shown in FIG. 10, antenna module 1020-A may receive some occasions of PRS, while antenna module 1020-B may receive other occasions. This can have a detrimental effect on positioning accuracy, which can be particularly problematic when centimeter-level (or less) accuracy is targeted.

Cellular-based positioning using antenna modules supporting 5G FR2 and/or 5G FR1 for can provide advantages over implementations using legacy fourth or earlier generation antennas. For example, a configuration including two 5G WWAN antenna modules like the configuration shown in FIG. 10 can obtain better signal reception capability from all angles based on the coverage of antenna modules 1020-A and 1020-B, while the enhanced precision of cell-based positioning techniques using smaller wavelength (higher frequency) transmission/reception can enable better performance for location-based services. Additionally, higher bandwidths, massive MIMO, and better beamforming can increase positioning accuracy, which can be particularly beneficial for some emerging positioning techniques such as AoA/RTT.

Although 5G FR1 and FR2-enabled antenna modules can provide a number of advantages, it can be challenging to manage antenna capability and use in different situations. Aspects of the disclosure provide techniques and protocols for antenna module type selection and antenna module capability reporting for positioning.

According to some aspects of the disclosure, a cellular-based positioning process using a particular antenna module type of a plurality of WWAN antenna module types available at the wireless device can be selected. The antenna module types for cell-based positioning can use different WWAN RF technologies/RATs and supported frequency ranges; for example, an antenna module type may support one or more frequency bands included in a frequency range for a 3G WWAN RF technology or a 4G WWAN RF technology, one or more frequency bands included in a FR1 frequency range for a 5G WWAN RF technology, one or more frequency bands included in a FR2 frequency range for a 5G WWAN RF technology, and/or support of 6G RATs/WWAN RF technologies and associated frequency ranges.

For implementations in which a wireless device includes one or more 5G FR2 supporting antenna modules, a wireless device can do more precise calculations for cellular-based positioning processes such as AoA/RTT when mmW beams are active. This accurate information can enable a location server to obtain accurate position estimations with AoA/RTT distance calculations. In some cases, if the location server requests a cellular-based positioning process (rather than hybrid cell/satellite assisted GNSS/LPPe positioning), active 5G antenna modules using FR2 mmW beams can enable accurate standalone 5G/6G cellular-based positioning processes.

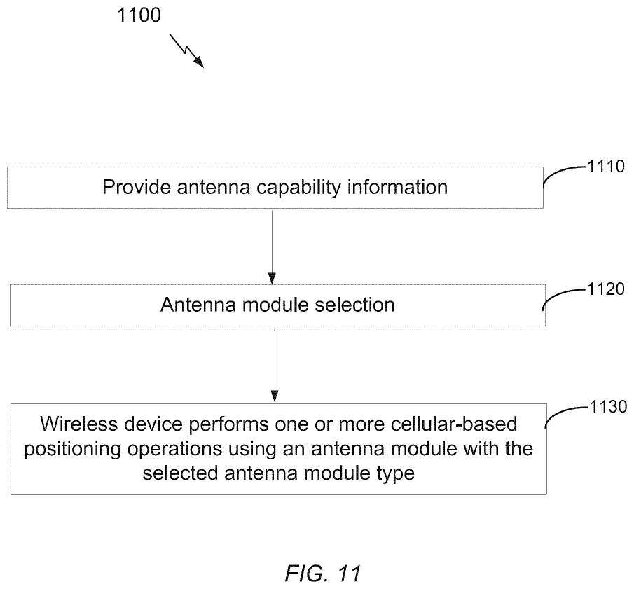

FIG. 11 shows an example process 1100 to enable positioning based on available antenna module types supporting one or more WWAN RF technologies, according to aspects of the disclosure. Process 1100 may be used for a wireless device such as a 5G-enabled user equipment (UE), a Cellular Vehicle to Everything (CV2X) modem, or customer premises equipment (CPE) with multiple WWAN antenna module types supporting multiple RF/RAT capabilities.

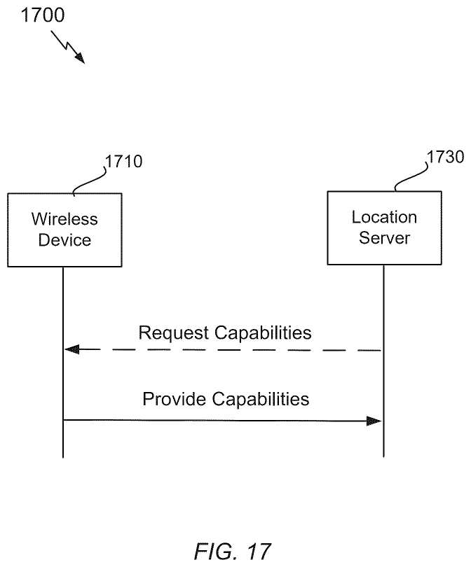

In some implementations, at 1110, a wireless device may provide antenna module capability information to a location server, such as a location server implementing a Location Management Function (LMF). Antenna module capability information may be transmitted and/or received as part of a positioning protocol such as LPP, NRPP, and/or other positioning protocol; for example, as illustrated in FIG. 17. In some aspects of the disclosure, antenna module capability information may include information indicative of a plurality of antenna module types included in the wireless device (e.g., supported WWAN RF technology, supported frequency range, etc.), a number of antenna modules having a particular WWAN antenna module type, a position on the wireless device of at least one antenna module (e.g., relative to a centroid or other location of the wireless device), WWAN antenna array information, and combinations thereof.

For an example of a wireless device such as a CPE with a plurality of moveable WWAN antenna modules, the antenna module capability information may include orientation information. For an example including at least one motorized panel with a plurality of pre-defined antenna module orientations, the antenna module capability information may include a number of panels, a number and relative orientation of each of the pre-defined antenna module orientations, etc. For an example including one or more moveable panels using at least some continuous orientation ranges, the antenna module capability information may include a number of panels and information indicative of the orientation range.

According to some aspects of the disclosure, the antenna module capability information is communicated as part of positioning protocol(s) using one or more Information Elements (IEs). For example, an Antenna_type IE can indicate that one or more antenna modules of the specified WWAN antenna module type are included in the wireless device, indicating at least the supported WWAN RF technology. A Support_type IE can indicate one or more frequency ranges supported by at least one antenna module included in the wireless device, such 5G FR1, 5G FR2, one or more supported bands within 5G FR1 and/or 5G FR2, one or more LTE frequency ranges/bands, one or more 3G frequency ranges/bands, etc. For the example of a QTM antenna module supporting 5G WWAN RF technology for 5G FR1 and/or 5G FR2 (such as one of the QTM modules described above), a QTM_Support_type IE can indicate whether a QTM antenna module included in the wireless device supports 5G FR1 (sub-6 GHz), 5G FR2 (mmW), or both frequency ranges. A Number_of_Antennas IE can indicate a number of antennas having a particular antenna type are included in the wireless device. For the example of a QTM antenna module type, an IE Number_of_QTMs can indicate how may QTM modules are included in the wireless device.

At 1120, a particular WWAN antenna module type may be selected for positioning, based on recommendation by the wireless device and/or a network entity. Herein, “antenna module type selection” and similar phrasing refers to selection of a cellular-based positioning process using a particular WWAN and frequency range to perform positioning operations that uses a particular antenna module type (or antenna module). In some examples, the particular antenna module type or antenna module may be explicitly indicated, while in some examples the particular antenna module type used is implicitly indicated by configuration information for the selected positioning process and/or by selection of a particular antenna module having the antenna module type. For example, a cellular-based positioning session can be selected/configured for 5G NR and one or more frequency bands included in the FR2 frequency range or the FR1 frequency range, implicitly selecting a particular WWAN antenna module type with FR2/FR1 capability.

Positioning using a selected WWAN antenna module type may be triggered in a number of ways; for example, based on wireless device or network/LMF initiation of positioning of wireless device, based on one or more use cases, based on connection status, etc. The positioning process using a particular antenna module type may be selected based on a supported WWAN RF technology, one or more supported frequency ranges, or both, and further based on one or more parameters. The one or more parameters may include one or more signal propagation parameters (such as an indication of LOS/NLOS transmission between an antenna module and one or more TRPs of a base station, beamforming capability/array size, etc.), one or more signal quality parameters (such as RSRP, RSRQ, SINR, etc.), one or more positioning quality parameters (such as a target precision/accuracy), one or more use case indications (such as use case type, use case positioning requirements, use case rules/preferences, etc.), one or more other conditions (e.g., availability of a connection with the particular WWAN RF technology/frequency range), or combinations thereof.

In some aspects, the selected cellular-based positioning process may default to a positioning process based on selection of a preferred WWAN antenna module type in the absence of one or more parameters indicating a different WWAN antenna module type should be used. For example, where the wireless device includes at least one antenna module supporting a 5G WWAN and 5G FR1 and/or 5G FR2 frequency range, the positioning process can default to a preferred 5G cellular-based FR1 or FR2 process using an antenna module supporting 5G FR1 and/or FR2 for some use cases, with a fallback to a cellular-based positioning process using an antenna module supporting a different WWAN RF technology and/or frequency range. For example, if the wireless device includes one or more 5G FR2 antenna modules, a cellular-based 5G positioning process using a supported mmW frequency band of a 5G FR2 antenna module can be selected in the absence of one or more parameters indicating a different antenna module type should be used.

In some cases, the selected positioning process can default to a less accurate positioning process using the associated selected WWAN antenna module type, with a fallback to a more precise/accurate process used under certain circumstances. For example, where the wireless device includes at least one antenna module supporting one or more 5G FR2 mmW bands, the selected positioning process may default to a preferred 5G FR1, 4G, or 3G positioning process using a selected antenna module in the absence of one or more parameters indicating 5G FR2 should be used (such as a use case parameter indicating a location service with a high target precision/accuracy).

In some aspects, a positioning process using a selected WWAN antenna module type may be selected at least partially based on an indication of one or more signal propagation parameters, one or more signal quality parameters, one or more positioning quality parameters, one or more use case parameters, or the combination thereof. For example, if one or more signal propagation parameters indicates insufficient LOS signaling, 5G FR2 positioning may be deemed insufficiently reliable and 5G FR1 positioning, 4G positioning, 3G positioning, or other positioning may be recommended.

As noted above, in some cases a positioning process using a particular WWAN antenna module type/antenna module may be recommended by the wireless device, while in some cases it may be recommended by a location server (e.g., implementing a Location Management Function). In some aspects of the disclosure, the wireless device may request configuration/assistance data for a cellular-based positioning process that uses a selected WWAN antenna module type/selected WWAN antenna module, and in response may receive configuration/assistance data to perform a positioning process using the selected antenna module. In some aspects of the disclosure, the wireless device may send antenna module capability information outlining the WWAN antenna module types available, as well as indication(s) of one or more parameters to the location server to enable the location server to recommend a positioning process/antenna module type/antenna module.

At 1130, the wireless device may perform one or more cellular-based positioning operations using an antenna module with the selected WWAN antenna module type. For example, the wireless device may have received configuration information for a cellular-based positioning process such as those described herein (e.g., TDOA, DL-AoD, UL-AoA, multi-cell RTT, AoA/RTT, or E-CID), and perform the one or more positioning operations in accordance with the configuration information. The configuration information may include configuration of a positioning session for the positioning process, assistance information to perform the operations of the positioning process using the selected WWAN RF technology and associated frequency range corresponding to the selected antenna module type, or combinations thereof.

As noted above, if the wireless device includes more than one antenna module of the selected antenna module type, one of the antenna modules may be selected for one or more positioning operations of the selected positioning process. According to some aspects of the disclosure, the wireless device may select an antenna module for positioning operations; for example to obtain a target radio link quality, based on one or more signal quality parameters and/or signal environment parameters. For example, for a selected AoA/RTT positioning process using a 5G FR2 antenna module type, the wireless device may select an antenna module having good LOS signaling and signal quality for one or more positioning operations.

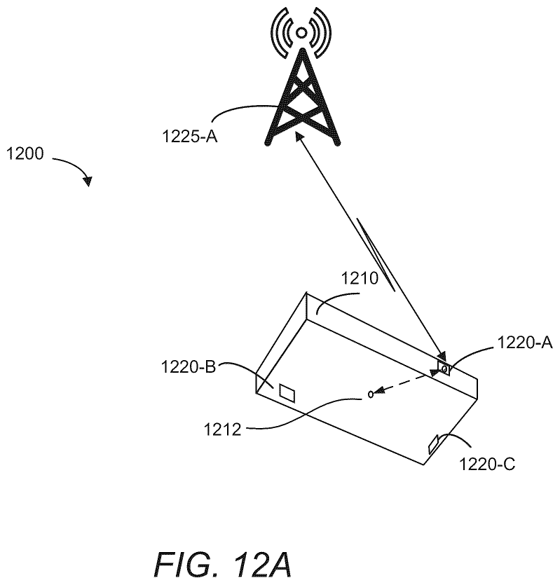

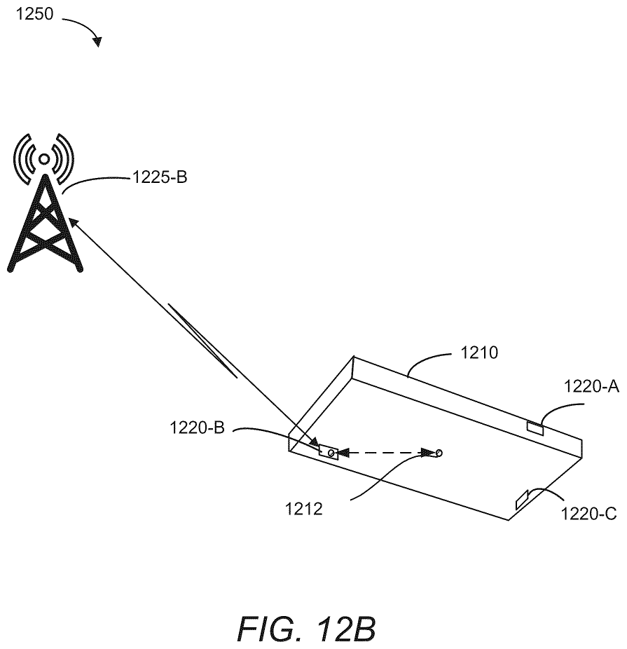

FIGS. 12A and 12B illustrate AoA/RTT positioning using two different base stations and two different 5G FR2 antenna modules selected by the wireless device to perform positioning operations.

FIG. 12A shows an example of an AoA/RTT positioning operation 1200. Wireless device 1210 has three 5G FR2-enabled antenna modules 1220-A, 1220-B, and 1220-C available for a selected AoA/RTT positioning process using a 5G FR2 antenna module type. Wireless device 1210 selects antenna module 1220-A for the positioning operation shown in FIG. 12A; e.g., based on signal quality parameters and LOS availability for a first base station 1225-A. Similarly, FIG. 12B shows an example of an AoA/RTT positioning operation 1250 in which wireless device 1210 selects antenna module 1220-B for transmitting beamformed mmW signals to a second base station 1225-B; e.g., based on signal quality parameters and LOS availability.

In some cases, a positioning result derived from beamformed mmW signaling can have centimeter-level accuracy, but the positioning results for each of the above measurements will indicate the position of the antenna modules 1220-A and 1220-B rather than a centroid 1212 of wireless device 1210. In some aspects of the disclosure, positioning results associated with each of the antenna modules can be corrected from the derived position to a reference location on the wireless device, such as the centroid of wireless device 1210, a reference location corresponding to one of the antennas, or other reference location.

According to some aspects of the disclosure, WWAN antenna module type/antenna module selection may be performed in the context of particular use cases. Example use cases that may trigger antenna module type selection for positioning include positioning for a wireless device with multi-SIM capability, for a wireless device in a RAN sharing environment, for a wireless device designated as a leader for a positioning group use case, for a wireless device with GNSS concurrency with WWAN capability, or combinations thereof.

In an aspect of the disclosure, WWAN antenna module type selection may be initiated to perform cellular-based positioning for a wireless device that includes more than one subscriber unit (e.g., a multi-SIM UE), based on a use case parameter indication of multi-SIM use.

Multi-SIM devices provide users with the ability to use two or more SIM cards in one mobile device. With multi-SIM capability the user has the flexibility to (for example) subscribe to data and voice plans from more than one operator using the same mobile device, allowing for powerful use cases such as managing personal and work numbers on the same device, or optimizing monthly subscription costs.

In general, multi-SIM capability is relatively complex and involves the interaction of various modules in the modem-RF system (sometimes referred to as the chipset). The modem-RF system design can enable management of two different networks and subscriptions simultaneously, while providing users with a high-quality experience on both subscriptions. Multi-SIM design can account for many scenarios of network configurations across geographies, SIM card combinations, and user preferences. For some modem-RF implementations and supporting algorithms, connection to a multi-SIM device may perform like a single-SIM device in terms of data throughput, power consumption, page reliability and other performance metrics.

In addition, a multi-SIM device may support multiple generations of Radio Access Technologies (RAT) across both SIM cards, from 5G and 4G to legacy and emerging generations, and may need to connect to the same or different generations of technologies simultaneously.

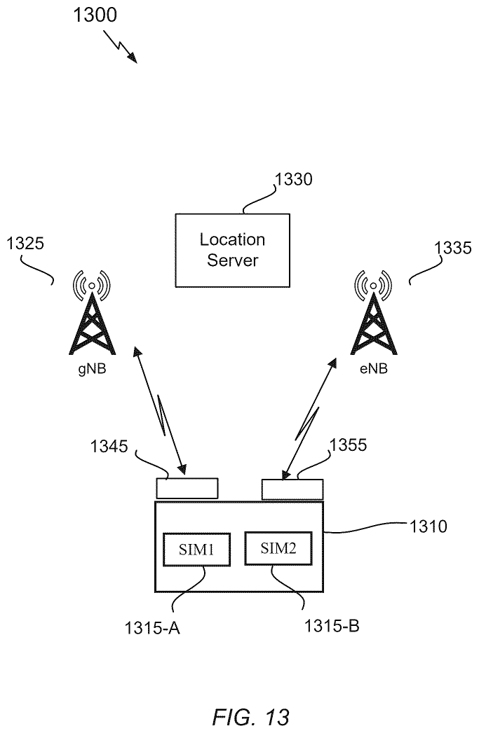

FIG. 13 shows an example configuration 1300 for a wireless device 1310 including at least a first SIM 1315-A associated with a first subscription (SUB1) and a second SIM 1315-B associated with a second subscription (SUB2). Wireless device 1310 includes at least a first WWAN antenna module 1345 with 5G FR1 and/or FR2 capability and at least a second WWAN antenna module 1355 with 3G and/or 4G capability, and can include other antennas such as those outlined above. Wireless device 1310 may be in communication with a network entity such as a location server 1330 via base stations gNB 1325 and/or eNB 1335 and enable positioning using LPP, NRPP, and/or other location protocols. At the time represented in FIG. 13, SUB1 is camped on a 5G cell of gNB 1325 and SUB2 is camped on a 4G cell of eNB 1335.

As noted above, antenna module type selection may be triggered in a number of ways; for example, based on wireless device or network initiation of positioning of wireless device 1310. Wireless device 1310 and/or a location server 1330 may recommend a positioning process using the first WWAN antenna module 1345 or the second WWAN antenna module 1355, based at least on the supported WWAN RF technology, supported frequency range, and one or more use case parameters indicating the multi-SIM use case.

In one example, WWAN antenna module type selection may default to a positioning process using a selected WWAN antenna module supporting a 5G RAT and 5G FR1 and/or 5G FR2 frequency range for a multi-SIM use case with at least one SUB camped on a 5G cell (e.g., using SIM 1315-A). In some implementations, antenna module type selection may consider one or more additional parameters. The one or more parameters may include one or more signal propagation indications (such as an indication of LOS/NLOS transmission between an antenna module and one or more TRPs), one or more signal quality parameters (such as RSRP, RSRQ, and/or SINR), one or more positioning quality parameters (such as a target precision/accuracy, a preferred positioning technique such as AoA/RTT, etc.), one or more additional use case indications (e.g., SIM prioritization rules/preferences), or combinations thereof. In some cases, where signal propagation/signal quality problems unduly affect 5G signaling between first WWAN antenna module 1345 and base station gNB 1325, wireless device 1310 may first determine whether another gNB is available to remedy the signal propagation/signal quality problems and select second WWAN antenna module 1355 if none are available.

In an implementation where the WWAN service provider is the same for both SUBs of a dual-SIM wireless device 1310, the positioning session can be initiated directly using the SUB associated with 5G communication for better accuracy, since the same LMF may be used and wireless device 1310 need not initiate a Network-Originated Location Request (NO-LR) or Mobile-Originated Location Request (MO-LR).

In another aspect of the disclosure, antenna module type selection can used for cellular-based positioning for a wireless device based on a use case parameter indication of a RAN sharing environment. In a shared RAN environment, a wireless device such as a UE can be served through the RAN of its home operator or the RAN of another service operator in the sharing system. Consequently, when the home operator is unable to serve its UE, and there is more than one available service operator, a RAN selection decision may be made.

For RAN sharing, two common solutions are known as Multi Operator Core Network (MOCN) and Multi Operator RAN (MORAN). In accordance with MORAN, everything in the RAN (antenna, tower, site, power) except the radio carriers is shared between two or more operators. In accordance with MOCN, two or more core networks share the same RAN (i.e., meaning the carriers are shared). The existing core networks may be kept separate. MOCN is a resource efficient solution as it gives the mobile operators the opportunity to pool their respective spectrum allocations, resulting in improved trunking efficiency.

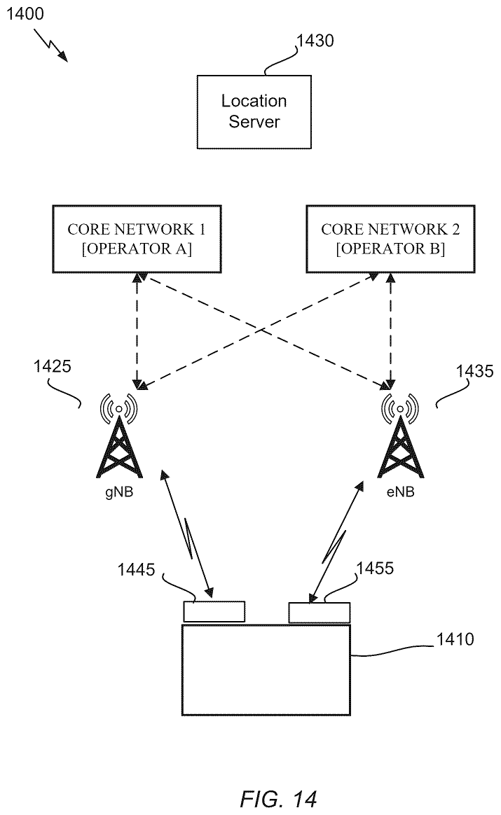

According to aspects of the disclosure, antenna module type selection may be initiated to perform cellular-based positioning for a wireless device in a RAN sharing system. FIG. 14 illustrates an example RAN sharing system 1400, according to aspects of the disclosure. In FIG. 14, a wireless device 1410 may communicate with gNB 1425, using WWAN antenna module 1445 which supports one or more frequency bands included in 5G FR1, 5G FR2, or a combination thereof. Wireless device 1410 may communicate with eNB 1435 using WWAN antenna module 1455, which supports one or more frequency bands included in a 4G frequency range.

In the example of FIG. 14, wireless device 1410 has an operator A home Public Land Mobile Network (PLMN) card but Operator A does not support 5G FR1 and/or FR2 related features or services in a current service area, while Operator B is another service provider accessible to wireless device 1410 through a RAN sharing scheme that supports 5G FR2 with beamforming. As depicted in FIG. 14, eNB 1435 is associated with core network 1 (Operator A) and gNB 1425 is associated with core network 2 (Operator B). To facilitate the RAN sharing between the LTE RAN and the 5G NR RAN, the core networks 1 and 2 may communicate with both the eNB and the gNB via user data plane signaling and/or user control plane signaling.

According to some aspects of the disclosure, antenna module type selection between a positioning process using WWAN antenna module 1445 or WWAN antenna module 1455 may be triggered in a number of ways; for example, based on wireless device or network initiation of positioning of wireless device 1410. Wireless device 1410 and/or a location server 1430 may recommend a positioning process using WWAN antenna module 1445 or WWAN antenna module 1455, based at least on the supported WWAN RF technology, supported frequency range, and one or more parameters indicating a RAN-sharing use case.

As with the multi-SIM use case, antenna module type selection may default to a positioning process using a selected WWAN antenna module 1445 supporting a 5G RAT and 5G FR1 and/or 5G FR2 frequency range for a RAN sharing use case with access to a 5G service provider (e.g., Operator B), if the home PLMN of the wireless device (e.g. Operator A) does not support 5G FR1 and/or FR2. In another example, antenna module type selection may default to a positioning process using a selected antenna module type associated with the home PLMN Operator A based on wireless device/user preference, and may have more limited circumstances for selecting an antenna module associated with Operator B. For example, home PLMN Operator A (and antenna module 1455) may be selected for positioning unless a target precision/accuracy exceeds a threshold, and Operator B (and antenna module 1445) can be selected for positioning using 5G FR2 mmW signaling.

In some aspects, antenna module type selection for a network sharing use case may consider one or more additional parameters; e.g., one or more signal propagation indications (such as an indication of LOS/NLOS transmission between an antenna module and one or more TRPs, angular signal reception/transmission capability of antenna module(s), etc.), one or more signal quality parameters (such as RSRP, RSRQ, SINR, etc.), one or more positioning quality parameters (such as a target precision/accuracy, a preferred positioning technique such as AoA/RTT, etc.), one or more additional use case indications (such as preference for the home PLMN versus another service provider for a networking sharing use case), or combinations thereof.

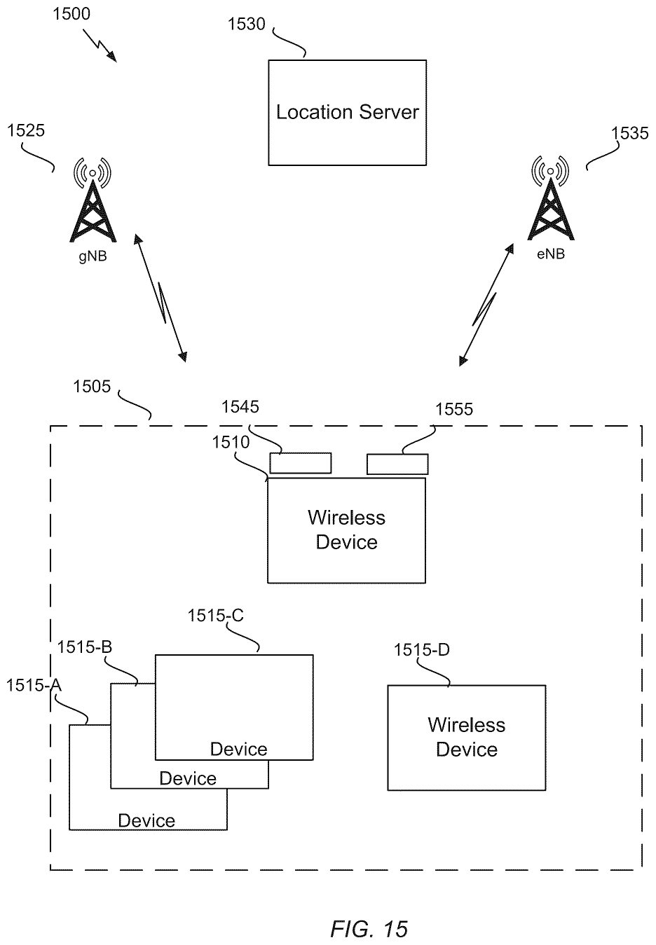

According to aspects of the disclosure, antenna module type selection may be initiated to perform cellular-based positioning for a wireless device for a positioning group use case in which a wireless device is designated as a leader device. FIG. 15 shows a configuration 1500 of a positioning group 1505 including a wireless device 1510 designated as a leader, as well as one or more other devices 1515-A, 1515-B, and 1515-C to be positioned. In some cases, the positioning group 1505 may also include a wireless device 1515-D designated as a validator device to validate a position estimate of the leader. The devices to be positioned (e.g., devices 1515-A to 1515-C) may have less positioning capability (e.g., only short-range positioning), may be power constrained (e.g., battery-operated), or otherwise less able to provide consistent and accurate positioning. In some cases, the leader device and the other devices may be cellular phones, with the leader device having more positioning capability and/or more access to power.

For a positioning group, a leader device may be chosen to determine its location and share estimated position information with other devices in the group (for example, with device-to-device communication). A validator device can also be chosen to validate the position of the leader device, to help ensure accuracy. Moreover, in some cases, the positioning method used by the validator device may complement the positioning method used by the leader device, which can help ensure accuracy and robustness of the location determination.

A positioning group may be defined for a set of devices at a particular place and time. In response to movement among the devices (e.g., during a journey for an asset tag implementation), a group may re-designate devices (e.g., periodically) so that different devices may play the role of leader and validator, thereby spreading the power savings and other benefits among devices in the group.

According to aspects of the disclosure, one or more wireless devices with 5G capable antenna module(s) can be designated a “leader” among a group of devices with at least some device(s) not enabled for 5G NR positioning, and antenna selection may be based on a leader designation. The leader can perform positioning operations to generate a positioning result, and a derived position can be shared with others of the group of devices (e.g., either through signaling with one or more network devices or using device-to-device communications). In some cases, the devices themselves need not receive information indicative of the position. For example, a group of one or more IoT assets with asset trackers may be located proximate one or more wireless devices such as a 5G-enabled smartphone including a cellular modem, or CV2X cellular modem for a vehicle or other transport entity. Positioning using the 5G antenna module(s) supporting FR1 and/or FR2 for the smartphone or CV2X modem can be selected, and the derived location can be assigned to/shared with the IoT assets.

According to aspects of the disclosure, wireless device 1510 includes at least a first WWAN antenna module 1545 with 5G FR1 and/or FR2 capability and at least a second WWAN antenna module 1555 with 3G/4G capability, as well as other antennas such as those outlined above. Wireless device 1510 may be able to communicate with base station gNB 1525 or wireless device eNB 1535 at the time illustrated in FIG. 15, and may communicate with location server 1530 via one of the base stations using LPP/NRPP protocols to enable positioning.

According to some aspects, antenna module type selection between a positioning process using first WWAN antenna module 1545 and second WWAN antenna module 1555 may be triggered in a number of ways; for example, based on wireless device or network initiation of positioning of wireless device 1510, upon formation of positioning group 1505, upon designation of wireless device 1510 as a leader device, etc. Wireless device 1510 and/or location server 1530 may recommend positioning using the first antenna module 1545 or the second antenna module 1555. One or more positioning operations using a selected positioning process with a selected WWAN antenna module type may be performed, and estimated position information may be shared with one or more of devices 1515-A to 1515-C (e.g., using device-to-device communication) and/or shared with location server 1530 (e.g., using LPP protocol, NRPP protocol, or other protocol).

For example, antenna module type selection for a wireless device designated as a leader device in a positioning group use case may default to a positioning process using a selected WWAN antenna module type supporting a 5G RAT and 5G FR1 and/or 5G FR2 frequency range, to provide enhanced positioning of devices 1515-A to 1515-C. In some implementations, antenna module type selection may consider one or more additional parameters. The one or more parameters may include one or more signal propagation indications (such as an indication of LOS/NLOS transmission between an antenna module and one or more TRPs), one or more signal quality parameters (such as RSRP, RSRQ, and/or SINR), one or more positioning quality parameters (such as a target precision/accuracy, a preferred positioning technique such as AoA/RTT, etc.), one or more additional use case indications (e.g., a positioning group type, one or more power constraint indications, etc.), or combinations thereof.

In another aspect, antenna module selection may be used for a use case of hybrid cellular-based and satellite-based positioning, where GNSS positioning is concurrent with WWAN positioning. Concurrent WWAN and GNSS positioning with the GPS L1 band can experience some interference with some WWAN bands. For example, communication using LTE B13 and the NR FR1 bands (particularly n24 and NTN n255) can interfere with GNSS reception of signals using the GPS L1 band, which can impact overall GNSS performance and may cause a fix outage. According to aspects of the disclosure, a wireless device may use antenna module selection to mitigate possible interference between GNSS and cellular transmissions for a hybrid 5G-GNSS positioning process. Table 1 shows some applicable bands and associated frequency information.

TABLE 1

| Band Type | Band Name | Frequency Range |
|---|---|---|
| LTE | B13 | 746-756 MHz (downlink) |
| GPS | L1 | 1563-1587 MHz |
| 5G FR1 | n24 | 1525-1559 MHz (downlink) |
| NTN | n255 | 1525-1559 MHz (downlink) |
| 5G FR2 | n257 | 26.50-29.50 GHz (uplink/downlink) |
| 5G FR2 | n258 | 24.25-27.50 GHz (uplink/downlink) |
| 5G FR2 | n259 | 39.50-43.50 GHz (uplink/downlink) |
| 5G FR2 | n260 | 37.00-40.00 GHz (uplink/downlink) |
| 5G FR2 | n261 | 27.50-28.35 GHz (uplink/downlink) |
| 5G FR2 | n262 | 47.20-48.20 GHz (uplink/downlink) |
| 5G FR2 | n263 | 57.00-71.00 GHz (uplink/downlink) |

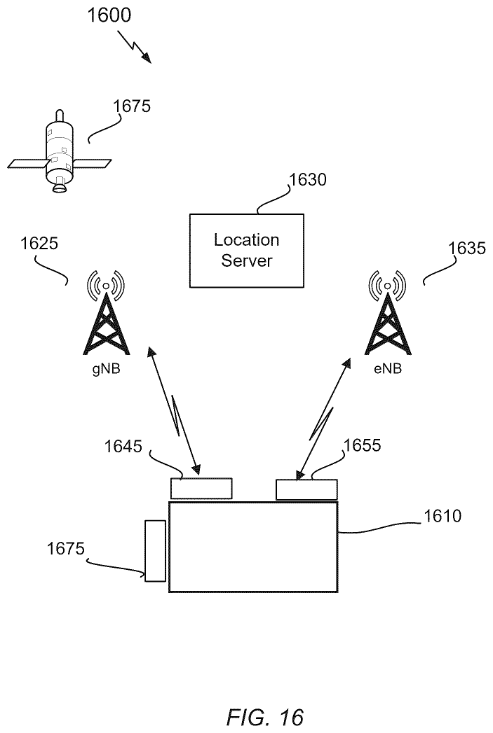

In this example, one or more WWAN antenna modules associated with the 5G FR2 band may be selected for WWAN transmissions and reception, while GNSS signals are received with one or more antenna modules configured for their reception. FIG. 16 illustrates a configuration 1600 in which a wireless device 1610 performs concurrent WWAN and GNSS positioning.

In a hybrid 5G-GNSS positioning using GPS L1 band signals from one or more satellites 1675, wireless device 1610 selects a cellular-based positioning process using a non-interfering frequency band included in the 5G FR2 range that uses selected WWAN antenna module 1645, gNB 1625, and location server 1630. For example, if wireless device 1610 is using an LTE B13, NTN n255, or n24 FR1 frequency band using WWAN antenna module 1655 in communication with eNB 1635, it can switch to 5G FR2 positioning using WWAN antenna module 1645 in communication with gNB 1625 and a supported FR2 frequency band (e.g., one of the FR2 bands in Table 1). As a result, interference between the cellular signals and satellite signals to be mitigated/eliminated, decreasing or eliminating fix outage that can accompany interference.

As noted above, antenna module capability information can be provided to a location server. FIG. 17 illustrates an example capability exchange 1700 between a location server 1730 and a wireless device 1710, according to some aspects of the disclosure. At 1715, location server 1730 may optionally request antenna module capability information from wireless device 1710. At 1725, wireless device 1710 may provide the requested antenna module capability information or provide unsolicited antenna module capability information.

For example, an Antenna_type IE can indicate the presence of one or more antenna modules of the specified antenna module type are included in the wireless device; for example, one or more 5G FR1 and/or 5G FR2 WWAN antenna modules, one or more 4G WWAN antenna modules, one or more 3G WWAN antenna modules, etc. An antenna type IE can enable the location server to select a suitable cell-based positioning technique. For example, if wireless device 1710 includes one or more antenna modules supporting 5G FR2, the location server can suggest mmW beam positioning for enhanced accuracy.

A support type IE can indicate one or more frequency ranges supported by at least one antenna module included in wireless device 1710. For example, a QTM_Support_type IE can indicate whether a QTM antenna module included in the wireless device supports 5G FR1 (sub-6 GHz), 5G FR2 (mmW), or both frequency ranges. A number of antenna modules IE can indicate a number of antenna modules with a particular WWAN antenna module type are included in the wireless device. For the example of a QTM antenna module type, an IE Number_of_QTMs can indicate how may QTM modules are included in the wireless device.

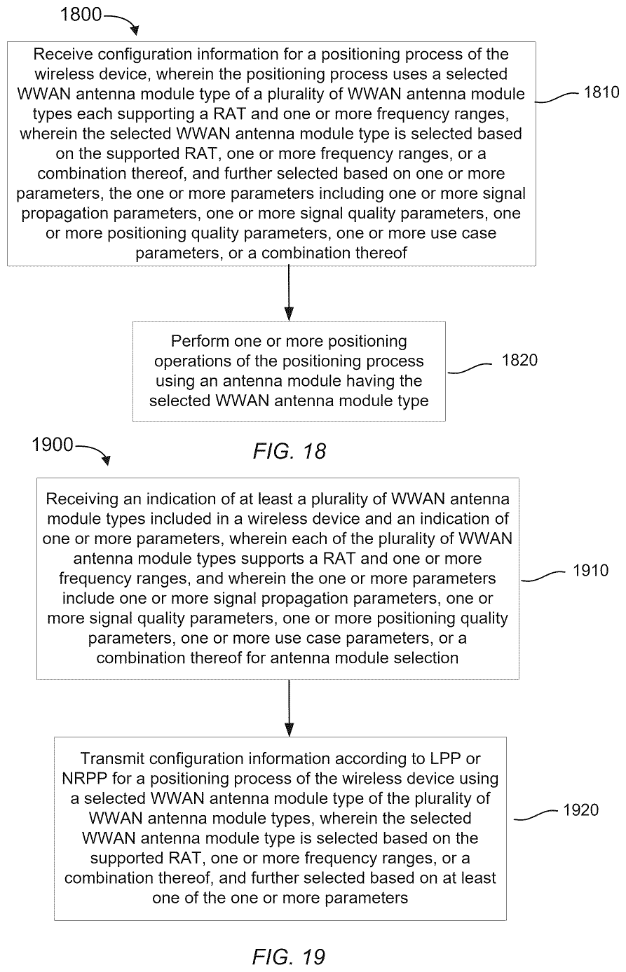

FIG. 18 illustrates an example method 1800 of wireless communication, according to aspects of the disclosure. In an aspect, method 1800 may be performed by a wireless device/UE (e.g., any of the devices described herein).

At 1810, a wireless device including a plurality of antenna modules may receive configuration information for a positioning process of the wireless device, wherein the positioning process uses a selected WWAN antenna module type of a plurality of WWAN antenna module types each supporting a RAT and one or more frequency ranges, wherein the selected WWAN antenna module type is selected based on the supported RAT, one or more frequency ranges, or a combination thereof, and further selected based on one or more parameters, the one or more parameters including one or more signal propagation parameters, one or more signal quality parameters, one or more positioning quality parameters, one or more use case parameters, or a combination thereof.

In some aspects, operation 1810 may be performed, for example, using WWAN transceiver(s) 310, short range transceiver(s) 320, processor(s) 342, positioning component(s) 348, and/or memory 340 of UE 302, which may be considered means (structure) for performing operation 1810.

At 1820, the wireless device may perform one or more positioning operations of the positioning process using an antenna module having the selected WWAN antenna module type.

In some aspects, operation 1820 may be performed, for example, using WWAN transceiver(s) 310, short range transceiver(s) 320, processor(s) 342, positioning component(s) 348, and/or memory 340 of UE 302, which may be considered means (structure) for performing operation 1820.

FIG. 19 illustrates an example method 1900 of wireless communication, according to aspects of the disclosure. In an aspect, method 1900 may be performed by a network entity such as a location server.

At 1910, the location server may receive an indication of at least a plurality of WWAN antenna module types included in a wireless device and an indication of one or more parameters, wherein each of the plurality of WWAN antenna module types supports a RAT and one or more frequency ranges, and wherein the one or more parameters include one or more signal propagation parameters, one or more signal quality parameters, one or more positioning quality parameters, one or more use case parameters, or a combination thereof for antenna module selection.

In some aspects, where the network entity is location server operation 1910 may be performed by the one or more network transceivers 390, the one or more processors 394, memory 396, and/or positioning component(s) 398, any or all of which may be considered means (structure) for performing this operation.

At 1920, the location server may transmit configuration information according to a Long Term Evolution Positioning Protocol (LPP) or New Radio Positioning Protocol (NRPP) for a positioning process of the wireless device using a selected WWAN antenna module type of the plurality of WWAN antenna module types, wherein the selected WWAN antenna module type is selected based on the supported RAT, one or more frequency ranges, or a combination thereof, and further selected based on at least one of the one or more parameters.

In some aspects, where the network entity is location server operation 1920 may be performed by the one or more network transceivers 390, the one or more processors 394, memory 396, and/or positioning component(s) 398, any or all of which may be considered means (structure) for performing this operation.

As will be appreciated, a technical advantage of the methods 1800 and 1900 is enabling positioning using a selected antenna module type for a wireless device. For example, when a WWAN antenna module type enabling 5G FR1 and/or FR2 frequency ranges is selected, the advanced positioning features of 5G and emerging advanced positioning techniques such as AoA/RTT can enable location services and features that use high quality positioning results. Further, for examples in which a wireless device includes multiple antenna modules of a selected antenna module type, the antenna module for a positioning operation can be selected to enable high quality reception capability from all or most angles, which can be particularly important for 5G FR2 enabled antenna modules.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of positioning performed by a wireless device including a plurality of antenna modules, comprising: receiving configuration information for a positioning process of the wireless device, wherein the positioning process uses a selected Wireless Wide Area Network (WWAN) antenna module type of a plurality of WWAN antenna module types each supporting a Radio Access Technology (RAT) and one or more frequency ranges, wherein the selected WWAN antenna module type is selected based on the supported RAT, one or more frequency ranges, or a combination thereof, and further selected based on one or more parameters, the one or more parameters including one or more signal propagation parameters, one or more signal quality parameters, one or more positioning quality parameters, one or more use case parameters, or a combination thereof; and performing one or more positioning operations of the positioning process using an antenna module having the selected WWAN antenna module type.

Clause 2. The method of clause 1, wherein the WWAN antenna module type is selected based on selecting the positioning process using a supported RAT of the WWAN antenna module type, a frequency range supported by the WWAN antenna module type, or a combination thereof, and further selected based on at least a use case parameter.

Clause 3. The method of any of clauses 1 to 2, further comprising: transmitting an indication of at least the supported RAT and one or more supported frequency ranges of each of the plurality of WWAN antenna module types of the wireless device and an indication of the one or more signal propagation parameters, one or more signal quality parameters, one or more positioning quality parameters, one or more use case parameters, or a combination thereof to a location server for selection of the selected WWAN antenna module type.

Clause 4. The method of any of clauses 1 to 3, wherein the plurality of antenna modules comprises: at least a first antenna module with a first WWAN antenna module type supporting a fifth generation (5G) RAT and further supporting a 5G FR1 frequency range, a 5G FR2 frequency range, or both; and at least a second antenna module with a second WWAN antenna module type supporting a fourth generation (4G) RAT and further supporting a frequency range including one or more 4G frequency bands, or with a second WWAN antenna module type supporting a third generation (3G) RAT and further supporting a frequency range including one or more 3G frequency bands.

Clause 5. The method of clause 4, wherein the wireless device is in communication with a 5G base station using a first subscription for a first Subscriber Identity Module (SIM) and using the first antenna module, and is further in communication with a 4G base station using a second subscription for a second SIM and using the second antenna module, and further comprising: selecting the first antenna module having the first WWAN antenna module type for the positioning process based at least on support of the 5G FR1 frequency range, the 5G FR2 frequency range, or both and further based at least on a use case parameter indicating multi-SIM use.

Clause 6. The method of clause 5, wherein selecting the first antenna module having the first WWAN antenna module type is based on support of the 5G FR2 frequency range and further based on at least one of the one or more signal propagation parameters indicating line of sight signaling, at least one of the one or more signal quality parameters indicating a signal quality exceeding a threshold, at least one of the one or more positioning quality parameters indicating a target accuracy exceeding a threshold, at least one of the one or more positioning quality parameters indicating a target precision exceeding a threshold, a use case parameter associated with 5G FR2 positioning, or a combination thereof.

Clause 7. The method of any of clauses 4 to 6, wherein the wireless device is in communication with a 5G base station using a first subscription for a first SIM and using the first antenna module, and is further in communication with a 4G base station using a second subscription for a second SIM and using the second antenna module, and further comprising: transmitting an indication of the one or more signal propagation parameters, the one or more signal quality parameters, the one or more positioning quality parameters, the one or more use case parameters, or the combination thereof, and wherein the configuration information comprises configuration of a positioning session using the first antenna module, assistance information to perform the one or more positioning operations using the first antenna module, or a combination thereof.

Clause 8. The method of clause 7, wherein the first subscription and the second subscription are both associated with a same WWAN service provider.

Clause 9. The method of any of clauses 4 to 8, wherein the wireless device is configured to communicate with a first Radio Access Network (RAN) or a second different RAN in a network sharing system.

Clause 10. The method of clause 9, wherein the first RAN is associated with a home Public Land Mobile Network (PLMN) operator that does not support 5G FR2 communications, and wherein the second different RAN is associated with a network operator that supports 5G FR2 communications, and further comprising: selecting the first WWAN antenna module type based at least on support of the 5G FR2 frequency range and further based on a use case parameter indicating network sharing.

Clause 11. The method of clause 10, wherein selecting the first WWAN antenna module type is further based on at least one of the or more signal propagation parameters indicating at least some line of sight signaling, at least one of the one or more signal quality parameters indicating a signal quality exceeding a threshold, at least one of the one or more positioning quality parameters indicating a target accuracy exceeding a threshold, at least one of the one or more positioning quality parameters indicating a target precision exceeding a threshold, at least one of the one or more use case parameters including a use case parameter associated with 5G FR2 positioning, or a combination thereof.

Clause 12. The method of any of clauses 4 to 11, further comprising: selecting the first WWAN antenna module type based on support of the 5G FR1 frequency range, the 5G FR2 frequency range, or both and further based at least on a use case parameter indicating the wireless device is a leader device located proximate to one or more other devices included in a positioning group; wherein performing the one or more positioning operations comprises performing one or more cellular-based positioning operations using the first antenna module; and sharing estimated position information for the positioning group.

Clause 13. The method of clause 12, wherein sharing the estimated position information for the positioning group comprises: transmitting the estimated position information to the one or more other devices included in the positioning group using device-to-device communication, transmitting the estimated position information to a location server; or a combination thereof.

Clause 14. The method of any of clauses 12 to 13, wherein the wireless device comprises a cellular modem included in a mobile phone or a cellular modem included in a vehicle, and wherein the one or more other devices include at least one asset tracker.

Clause 15. The method of any of clauses 4 to 14, wherein the positioning process is a concurrent 5G and Global Navigation Satellite System (GNSS) positioning process, and further comprising selecting the first WWAN antenna module type based at least on support of the 5G FR2 frequency range and further based on a use case parameter indicating 5G-GNSS positioning.

Clause 16. The method of any of clauses 1 to 15, further comprising: transmitting antenna module capability information to a location server; and receiving the configuration information for the positioning process of the wireless device in accordance with the antenna module capability information.

Clause 17. The method of clause 16, wherein transmitting antenna module capability information comprises transmitting: an indication of the plurality of WWAN antenna module types included in the wireless device; a number of antenna modules having one or more of the plurality of WWAN antenna module types; a position on the wireless device of at least one of the plurality of WWAN antenna modules; orientation information for at least one of the plurality of antenna modules having at least one motorized panel with a plurality of pre-defined antenna module orientations; or a combination thereof.

Clause 18. The method of clause 17, wherein the indication of WWAN antenna module type for at least a first antenna module of the plurality of antenna modules comprises an indication of 5G FR2 support for the at least the first antenna module, and wherein receiving the configuration information for the positioning process comprises receiving configuration information for an Angle of Arrival (AoA) and Round Trip Time (RTT) cell based positioning process using the first antenna module.

Clause 19. The method of any of clauses 1 to 18, wherein the wireless device includes a plurality of antenna modules having the selected WWAN antenna module type, and further comprising selecting one of the plurality of antenna modules having the selected WWAN antenna module type to perform at least one of the one or more positioning operations.

Clause 20. A method performed at a location server, comprising: receiving an indication of at least a plurality of Wireless Wide Area Network (WWAN) antenna module types included in a wireless device and an indication of one or more parameters, wherein each of the plurality of WWAN antenna module types supports a Radio Access Technology (RAT) and one or more frequency ranges, and wherein the one or more parameters include one or more signal propagation parameters, one or more signal quality parameters, one or more positioning quality parameters, one or more use case parameters, or a combination thereof for antenna module selection; and transmitting configuration information according to a Long Term Evolution Positioning Protocol (LPP) or New Radio Positioning Protocol (NRPP) for a positioning process of the wireless device using a selected WWAN antenna module type of the plurality of WWAN antenna module types, wherein the selected WWAN antenna module type is selected based on the supported RAT, one or more frequency ranges, or a combination thereof, and further selected based on at least one of the one or more parameters.

Clause 21. The method of clause 20, wherein the wireless device includes: at least a first antenna module with a first WWAN antenna module type supporting a fifth generation (5G) RAT and further supporting a 5G FR1 frequency range, a 5G FR2 frequency range, or both; and at least a second antenna module with a second WWAN antenna module type supporting a fourth generation (4G) RAT and further supporting a frequency range including one or more 4G frequency bands, or with a WWAN antenna module type supporting a third generation (3G) RAT and further supporting a frequency range including one or more 3G frequency bands.

Clause 22. The method of clause 21, further comprising: receiving an indication that the wireless device is in communication with a 5G base station using a first subscription for a first Subscriber Identity Module (SIM) and using the first antenna module, and is further in communication with a 4G base station using a second subscription for a second SIM and using the second antenna module; and selecting the first WWAN antenna module type based at least on support of the 5G FR1 frequency range, the 5G FR2 frequency range, or both and further based at least on a use case parameter indicating multi-SIM use.

Clause 23. The method of any of clauses 21 to 22, wherein the first WWAN antenna module type supports the 5G FR2 frequency range and further comprising: receiving an indication that the wireless device is in communication with a 5G base station using a first subscription for a first SIM and using the first antenna module, and is further in communication with a 4G base station using a second subscription for a second SIM and using the second antenna module, and further comprising: selecting the first WWAN antenna module type based on support of the 5G FR2 frequency range and further based on the one or more signal propagation parameters indicating at least some line of sight signaling, the one or more signal quality parameters indicating a signal quality exceeding a threshold, the one or more positioning quality parameters indicating a target accuracy exceeding a threshold, the one or more positioning quality parameters indicating a target precision exceeding a threshold, the one or more use case parameters including a use case parameter associated with 5G FR2 positioning, or a combination thereof; or selecting the second antenna module based on the one or more signal propagation parameters indicating non line of sight signaling, the one or more signal quality parameters indicating a signal quality below a threshold, the one or more positioning quality parameters indicating a target accuracy less than a threshold, the one or more positioning quality parameters indicating a target precision less than a threshold, or a combination thereof.

Clause 24. The method of any of clauses 21 to 23, further comprising: receiving an indication that the wireless device is configured to communicate with a first Radio Access Network (RAN) or a second different RAN in a network sharing system, wherein the first RAN is associated with a home Public Land Mobile Network (PLMN) operator for the wireless device that does not support 5G FR2 communications, and wherein the second different RAN is associated with a network operator that supports 5G FR2 communications, and further comprising: selecting the first WWAN antenna module type based at least on support of the 5G FR2 frequency range and further based on a use case parameter indicating network sharing.

Clause 25. The method of any of clauses 21 to 24, further comprising: receiving an indication that the wireless device is a leader device located proximate to one or more other devices included in a positioning group; and selecting the first WWAN antenna module type based on support of the 5G FR1 frequency range, the 5G FR2 frequency range, or both and further based at least on a use case parameter indicating the wireless device is a leader device located proximate to one or more other devices included in a positioning group.

Clause 26. The method of any of clauses 21 to 25, wherein the positioning process is a concurrent 5G and Global Navigation Satellite System (GNSS) positioning process, and further comprising: receiving positioning results from the wireless device for the concurrent 5G and GNSS process, the positioning results including cellular-based positioning results using the first WWAN antenna module type selected based at least on support of the 5G FR2 frequency range and further based on a use case parameter indicating 5G-GNSS positioning.

Clause 27. The method of any of clauses 20 to 26, further comprising: receiving antenna module capability information for the wireless device, wherein the wireless device includes a plurality of antenna modules and comprises a cellular modem included in a mobile phone, a cellular modem included in a vehicle, a cellular modem included in a Customer Premises Equipment (CPE), or a cellular modem included in a computing device, wherein the antenna module capability information for the wireless device comprises: an indication of the plurality of WWAN antenna module types included in the wireless device, including an indication of a supported RAT, one or more supported frequency ranges, or a combination thereof; a number of the plurality of antenna modules having at least a first WWAN antenna module type; a position on the wireless device of at least one of the plurality of antenna modules; orientation information for at least one of the plurality of antenna modules having at least one motorized panel with a plurality of pre-defined antenna module orientations; or a combination thereof.

Clause 28. The method of clause 27, wherein the antenna module capability information indicates the wireless device includes at least a first antenna module having 5G FR2 support, and wherein transmitting the configuration information for the positioning process of the wireless device using the selected WWAN antenna module type of the plurality of WWAN antenna module types comprises transmitting configuration information for the wireless device to perform Angle of Arrival (AoA) and Round Trip Time (RTT) cell based positioning process using the first antenna module.

Clause 29. A wireless device, comprising: one or more memories; one or more transceivers; and one or more processors communicatively coupled to the one or more memories and the one or more transceivers, the one or more processors, either alone or in combination, being configured to: receive, via the one or more transceivers, configuration information for a positioning process of the wireless device, wherein the positioning process uses a selected Wireless Wide Area Network (WWAN) antenna module type of a plurality of WWAN antenna module types each supporting a Radio Access Technology (RAT) and one or more frequency ranges, wherein the selected WWAN antenna module type is selected based on the supported RAT, one or more frequency ranges, or a combination thereof, and further selected based on one or more parameters, the one or more parameters including one or more signal propagation parameters, one or more signal quality parameters, one or more positioning quality parameters, one or more use case parameters, or a combination thereof; and perform one or more positioning operations of the positioning process using an antenna module having the selected WWAN antenna module type.

Clause 30. The wireless device of clause 29, wherein the WWAN antenna module type is selected based on selecting the positioning process using a supported RAT of the WWAN antenna module type, a frequency range supported by the WWAN antenna module type, or a combination thereof, and is further selected based on at least a use case parameter.

Clause 31. The wireless device of any of clauses 29 to 30, wherein the one or more processors, either alone or in combination, are further configured to: transmit, via the one or more transceivers, an indication of at least the supported RAT and one or more supported frequency ranges of each of the plurality of WWAN antenna module types of the wireless device and an indication of the one or more signal propagation parameters, one or more signal quality parameters, one or more positioning quality parameters, one or more use case parameters, or a combination thereof to a location server for selection of the selected WWAN antenna module type.

Clause 32. The wireless device of any of clauses 29 to 31, wherein the plurality of antenna modules comprises: at least a first antenna module with a first WWAN antenna module type supporting a fifth generation (5G) RAT and further supporting a 5G FR1 frequency range, a 5G FR2 frequency range, or both; and at least a second antenna module with a second WWAN antenna module type supporting a fourth generation (4G) RAT and further supporting a frequency range including one or more 4G frequency bands, or with a second WWAN antenna module type supporting a third generation (3G) RAT and further supporting a frequency range including one or more 3G frequency bands.

Clause 33. The wireless device of clause 32, wherein in response to the wireless device being in communication with a 5G base station using a first subscription for a first Subscriber Identity Module (SIM) and using the first antenna module, and further in communication with a 4G base station using a second subscription for a second SIM and using the second antenna module, the one or more processors, either alone or in combination, are further configured to: select the first antenna module having the first WWAN antenna module type for the positioning process based at least on support of the 5G FR1 frequency range, the 5G FR2 frequency range, or both and further based at least on a use case parameter indicating multi-SIM use.

Clause 34. The wireless device of clause 33, wherein the one or more processors, either alone or in combination, are further configured to select the first antenna module having the first WWAN antenna module type based on support of the 5G FR2 frequency range and further based on at least one of the one or more signal propagation parameters indicating line of sight signaling, at least one of the one or more signal quality parameters indicating a signal quality exceeding a threshold, at least one of the one or more positioning quality parameters indicating a target accuracy exceeding a threshold, at least one of the one or more positioning quality parameters indicating a target precision exceeding a threshold, a use case parameter associated with 5G FR2 positioning, or a combination thereof.

Clause 35. The wireless device of any of clauses 32 to 34, wherein in response to the wireless device being in communication with a 5G base station using a first subscription for a first SIM and using the first antenna module, and further in communication with a 4G base station using a second subscription for a second SIM and using the second antenna module, the one or more processors, either alone or in combination, are further configured to: transmit, via the one or more transceivers, an indication of the one or more signal propagation parameters, the one or more signal quality parameters, the one or more positioning quality parameters, the one or more use case parameters, or the combination thereof, and wherein the configuration information comprises configuration of a positioning session using the first antenna module, assistance information to perform the one or more positioning operations using the first antenna module, or a combination thereof.

Clause 36. The wireless device of clause 35, wherein the first subscription and the second subscription are both associated with a same WWAN service provider.

Clause 37. The wireless device of any of clauses 32 to 36, wherein the wireless device is configured to communicate with a first Radio Access Network (RAN) or a second different RAN in a network sharing system.

Clause 38. The wireless device of clause 37, wherein the first RAN is associated with a home Public Land Mobile Network (PLMN) operator that does not support 5G FR2 communications, and wherein the second different RAN is associated with a network operator that supports 5G FR2 communications, and wherein the one or more processors, either alone or in combination, are further configured to: select the first WWAN antenna module type based at least on support of the 5G FR2 frequency range and further based on a use case parameter indicating network sharing.

Clause 39. The wireless device of clause 38, wherein the one or more processors, either alone or in combination, are further configured to select the first WWAN antenna module type based on at least one of the or more signal propagation parameters indicating at least some line of sight signaling, at least one of the one or more signal quality parameters indicating a signal quality exceeding a threshold, at least one of the one or more positioning quality parameters indicating a target accuracy exceeding a threshold, at least one of the one or more positioning quality parameters indicating a target precision exceeding a threshold, at least one of the one or more use case parameters, the one or more processors, either alone or in combination, are configured to a use case parameter associated with 5G FR2 positioning, or a combination thereof.

Clause 40. The wireless device of any of clauses 32 to 39, wherein the one or more processors, either alone or in combination, are further configured to: select the first WWAN antenna module type based on support of the 5G FR1 frequency range, the 5G FR2 frequency range, or both and further based at least on a use case parameter indicating the wireless device is a leader device located proximate to one or more other devices included in a positioning group; perform one or more cellular-based positioning operations using the first antenna module; and share estimated position information for the positioning group.

Clause 41. The wireless device of clause 40, wherein, to share the estimated position information for the positioning group, the one or more processors, either alone or in combination, are configured to: transmit, via the one or more transceivers, the estimated position information to the one or more other devices included in the positioning group using device-to-device communication, transmitting the estimated position information to a location server; or a combination thereof.

Clause 42. The wireless device of any of clauses 40 to 41, wherein the wireless device comprises a cellular modem included in a mobile phone or a cellular modem included in a vehicle, and wherein the one or more other devices include at least one asset tracker.

Clause 43. The wireless device of any of clauses 32 to 42, wherein the positioning process is a concurrent 5G and Global Navigation Satellite System (GNSS) positioning process, and wherein the one or more processors, either alone or in combination, are further configured to select the first WWAN antenna module type based at least on support of the 5G FR2 frequency range and further based on a use case parameter indicating 5G-GNSS positioning.

Clause 44. The wireless device of any of clauses 29 to 43, wherein the one or more processors, either alone or in combination, are further configured to: transmit, via the one or more transceivers, antenna module capability information to a location server; and receive, via the one or more transceivers, the configuration information for the positioning process of the wireless device in accordance with the antenna module capability information.

Clause 45. The wireless device of clause 44, wherein the antenna module capability information comprises: an indication of the plurality of WWAN antenna module types included in the wireless device; a number of antenna modules having one or more of the plurality of WWAN antenna module types; a position on the wireless device of at least one of the plurality of antenna modules; orientation information for at least one of the plurality of antenna modules having at least one motorized panel with a plurality of pre-defined antenna module orientations; or a combination thereof.

Clause 46. The wireless device of clause 45, wherein the indication of WWAN antenna module type for at least a first antenna module of the plurality of antenna modules comprises an indication of 5G FR2 support for the at least the first antenna module, and wherein the configuration information for the positioning process comprises configuration information for an Angle of Arrival (AoA) and Round Trip Time (RTT) cell based positioning process using the first antenna module.

Clause 47. The wireless device of any of clauses 29 to 46, wherein the wireless device includes a plurality of antenna modules having the selected WWAN antenna module type, and wherein the one or more processors, either alone or in combination, are further configured to select one of the plurality of antenna modules having the selected WWAN antenna module type to perform at least one of the one or more positioning operations.

Clause 48. A location server, comprising: one or more memories; one or more transceivers; and one or more processors communicatively coupled to the one or more memories and the one or more transceivers, the one or more processors, either alone or in combination, being configured to: receive, via the one or more transceivers, an indication of at least a plurality of Wireless Wide Area Network (WWAN) antenna module types included in a wireless device and an indication of one or more parameters, wherein each of the plurality of WWAN antenna module types supports a Radio Access Technology (RAT) and one or more frequency ranges, and wherein the one or more parameters include one or more signal propagation parameters, one or more signal quality parameters, one or more positioning quality parameters, one or more use case parameters, or a combination thereof for antenna module selection; and transmit, via the one or more transceivers and according to a Long Term Evolution Positioning Protocol (LPP) or New Radio Positioning Protocol (NRPP), configuration information for a positioning process of the wireless device using a selected WWAN antenna module type of the plurality of WWAN antenna module types, wherein the selected WWAN antenna module type is selected based on the supported RAT, one or more frequency ranges, or a combination thereof, and further selected based on at least one of the one or more parameters.

Clause 49. The location server of clause 48, wherein the wireless device includes: at least a first antenna module with a first WWAN antenna module type supporting a fifth generation (5G) RAT and further supporting a 5G FR1 frequency range, a 5G FR2 frequency range, or both; and at least a second antenna module with a second WWAN antenna module type supporting a fourth generation (4G) RAT and further supporting a frequency range including one or more 4G frequency bands, or with a WWAN antenna module type supporting a third generation (3G) RAT and further supporting a frequency range including one or more 3G frequency bands.

Clause 50. The location server of clause 49, wherein the one or more processors, either alone or in combination, are further configured to: receive, via the one or more transceivers, an indication that the wireless device is in communication with a 5G base station using a first subscription for a first Subscriber Identity Module (SIM) and using the first antenna module, and is further in communication with a 4G base station using a second subscription for a second SIM and using the second antenna module; and select the first WWAN antenna module type based at least on support of the 5G FR1 frequency range, the 5G FR2 frequency range, or both and further based at least on a use case parameter indicating multi-SIM use.

Clause 51. The location server of any of clauses 49 to 50, wherein the first WWAN antenna module type supports the 5G FR2 frequency range and wherein the one or more processors, either alone or in combination, are further configured to: receive, via the one or more transceivers, an indication that the wireless device is in communication with a 5G base station using a first subscription for a first SIM and using the first antenna module, and is further in communication with a 4G base station using a second subscription for a second SIM and using the second antenna module; and select the first WWAN antenna module type based on support of the 5G FR2 frequency range and further based on the one or more signal propagation parameters indicating at least some line of sight signaling, the one or more signal quality parameters indicating a signal quality exceeding a threshold, the one or more positioning quality parameters indicating a target accuracy exceeding a threshold, the one or more positioning quality parameters indicating a target precision exceeding a threshold, the one or more use case parameters including a use case parameter associated with 5G FR2 positioning, or a combination thereof; or select the second antenna module based on the one or more signal propagation parameters indicating non line of sight signaling, the one or more signal quality parameters indicating a signal quality below a threshold, the one or more positioning quality parameters indicating a target accuracy less than a threshold, the one or more positioning quality parameters indicating a target precision less than a threshold, or a combination thereof.

Clause 52. The location server of any of clauses 49 to 51, wherein the one or more processors, either alone or in combination, are further configured to: receive, via the one or more transceivers, an indication that the wireless device is configured to communicate with a first Radio Access Network (RAN) or a second different RAN in a network sharing system, wherein the first RAN is associated with a home Public Land Mobile Network (PLMN) operator for the wireless device that does not support 5G FR2 communications, and wherein the second different RAN is associated with a network operator that supports 5G FR2 communications; and select the first WWAN antenna module type based at least on support of the 5G FR2 frequency range and further based on a use case parameter indicating network sharing.

Clause 53. The location server of any of clauses 49 to 52, wherein the one or more processors, either alone or in combination, are further configured to: receive, via the one or more transceivers, an indication that the wireless device is a leader device located proximate to one or more other devices included in a positioning group; and select the first WWAN antenna module type based on support of the 5G FR1 frequency range, the 5G FR2 frequency range, or both and further based at least on a use case parameter indicating the wireless device is a leader device located proximate to one or more other devices included in a positioning group.

Clause 54. The location server of any of clauses 49 to 53, wherein the positioning process is a concurrent 5G and Global Navigation Satellite System (GNSS) positioning process, and wherein the one or more processors, either alone or in combination, are further configured to: receive, via the one or more transceivers, positioning results from the wireless device for the concurrent 5G and GNSS process, the positioning results including cellular-based positioning results using the first WWAN antenna module type selected based at least on support of the 5G FR2 frequency range and further based on a use case parameter indicating 5G-GNSS positioning.

Clause 55. The location server of any of clauses 48 to 54, wherein the wireless device includes a plurality of antenna modules and comprises a cellular modem included in a mobile phone, a cellular modem included in a vehicle, a cellular modem included in a Customer Premises Equipment (CPE), or a cellular modem included in a computing device, and wherein the one or more processors, either alone or in combination, are further configured to receive, via the one or more transceivers, antenna module capability information for the wireless device, and wherein the antenna module capability information for the wireless device comprises: an indication of the plurality of WWAN antenna module types included in the wireless device, including an indication of a supported RAT, one or more supported frequency ranges, or a combination thereof; a number of the plurality of antenna modules having at least a first WWAN antenna module type; a position on the wireless device of at least one of the plurality of antenna modules; orientation information for at least one of the plurality of antenna modules having at least one motorized panel with a plurality of pre-defined antenna module orientations; or a combination thereof.

Clause 56. The location server of clause 55, wherein the antenna module capability information indicates the wireless device includes at least a first antenna module having 5G FR2 support, and wherein the one or more processors, either alone or in combination, are further configured to: transmit the configuration information for the positioning process of the wireless device using the selected WWAN antenna module type of the plurality of WWAN antenna module types comprises transmitting configuration information for the wireless device to perform Angle of Arrival (AoA) and Round Trip Time (RTT) cell based positioning process using the first antenna module.

Clause 57. A wireless device, comprising: means for receiving configuration information for a positioning process of the wireless device, wherein the positioning process uses a selected Wireless Wide Area Network (WWAN) antenna module type of a plurality of WWAN antenna module types each supporting a Radio Access Technology (RAT) and one or more frequency ranges, wherein the selected WWAN antenna module type is selected based on the supported RAT, one or more frequency ranges, or a combination thereof, and further selected based on one or more parameters, the one or more parameters including one or more signal propagation parameters, one or more signal quality parameters, one or more positioning quality parameters, one or more use case parameters, or a combination thereof; and means for performing one or more positioning operations of the positioning process using an antenna module having the selected WWAN antenna module type.

Clause 58. The wireless device of clause 57, wherein the WWAN antenna module type is selected based on selecting the positioning process using a supported RAT of the WWAN antenna module type, a frequency range supported by the WWAN antenna module type, or a combination thereof, and further selected based on at least a use case parameter.

Clause 59. The wireless device of any of clauses 57 to 58, further comprising: means for transmitting an indication of at least the supported RAT and one or more supported frequency ranges of each WWAN antenna module type of the wireless device and an indication of the one or more signal propagation parameters, one or more signal quality parameters, one or more positioning quality parameters, one or more use case parameters, or a combination thereof to a location server for selection of the selected WWAN antenna module type.

Clause 60. The wireless device of any of clauses 57 to 59, wherein the plurality of antenna modules comprises: at least a first antenna module with a first WWAN antenna module type supporting a fifth generation (5G) RAT and further supporting a 5G FR1 frequency range, a 5G FR2 frequency range, or both; and at least a second antenna module with a second WWAN antenna module type supporting a fourth generation (4G) RAT and further supporting a frequency range including one or more 4G frequency bands, or with a second WWAN antenna module type supporting a third generation (3G) RAT and further supporting a frequency range including one or more 3G frequency bands.

Clause 61. The wireless device of clause 60, wherein in response to the wireless device in communication with a 5G base station using a first subscription for a first Subscriber Identity Module (SIM) and using the first antenna module, and further in communication with a 4G base station using a second subscription for a second SIM and using the second antenna module, and further comprising: means for selecting the first antenna module having the first WWAN antenna module type for the positioning process based at least on support of the 5G FR1 frequency range, the 5G FR2 frequency range, or both and further based at least on a use case parameter indicating multi-SIM use.

Clause 62. The wireless device of clause 61, wherein selecting the first antenna module having the first WWAN antenna module type is based on support of the 5G FR2 frequency range and further based on at least one of the one or more signal propagation parameters indicating line of sight signaling, at least one of the one or more signal quality parameters indicating a signal quality exceeding a threshold, at least one of the one or more positioning quality parameters indicating a target accuracy exceeding a threshold, at least one of the one or more positioning quality parameters indicating a target precision exceeding a threshold, a use case parameter associated with 5G FR2 positioning, or a combination thereof.

Clause 63. The wireless device of any of clauses 60 to 62, wherein, and further comprising: means for transmitting an indication of the one or more signal propagation parameters, the one or more signal quality parameters, the one or more positioning quality parameters, the one or more use case parameters, or the combination thereof, in response to the wireless device being in communication with a 5G base station using a first subscription for a first SIM and using the first antenna module, and further in communication with a 4G base station using a second subscription for a second SIM and using the second antenna module; and wherein the means for receiving the configuration information comprises means for receiving configuration of a positioning session using the first antenna module, assistance information to perform the one or more positioning operations using the first antenna module, or a combination thereof.

Clause 64. The wireless device of clause 63, wherein the first subscription and the second subscription are both associated with a same WWAN service provider.

Clause 65. The wireless device of any of clauses 60 to 64, wherein the wireless device is configured to communicate with a first Radio Access Network (RAN) or a second different RAN in a network sharing system.

Clause 66. The wireless device of clause 65, wherein the first RAN is associated with a home Public Land Mobile Network (PLMN) operator that does not support 5G FR2 communications, and wherein the second different RAN is associated with a network operator that supports 5G FR2 communications, and further comprising: means for selecting the first WWAN antenna module type based at least on support of the 5G FR2 frequency range and further based on a use case parameter indicating network sharing.

Clause 67. The wireless device of clause 66, wherein the means for selecting the first WWAN antenna module type is further based on at least one of the or more signal propagation parameters indicating at least some line of sight signaling, at least one of the one or more signal quality parameters indicating a signal quality exceeding a threshold, at least one of the one or more positioning quality parameters indicating a target accuracy exceeding a threshold, at least one of the one or more positioning quality parameters indicating a target precision exceeding a threshold, at least one of the one or more use case parameters including means for a use case parameter associated with 5G FR2 positioning, or a combination thereof.

Clause 68. The wireless device of any of clauses 60 to 67, further comprising: means for selecting the first WWAN antenna module type based on support of the 5G FR1 frequency range, the 5G FR2 frequency range, or both and further based at least on a use case parameter indicating the wireless device is a leader device located proximate to one or more other devices included in a positioning group; wherein the means for performing the one or more positioning operations comprises means for performing one or more cellular-based positioning operations using the first antenna module; and means for sharing estimated position information for the positioning group.

Clause 69. The wireless device of clause 68, wherein the means for sharing the estimated position information for the positioning group comprises: means for transmitting the estimated position information to the one or more other devices included in the positioning group using device-to-device communication, transmitting the estimated position information to a location server; or a combination thereof.

Clause 70. The wireless device of any of clauses 68 to 69, wherein the wireless device comprises a cellular modem included in a mobile phone or a cellular modem included in a vehicle, and wherein the one or more other devices include at least one asset tracker.

Clause 71. The wireless device of any of clauses 60 to 70, wherein the positioning process is a concurrent 5G and Global Navigation Satellite System (GNSS) positioning process, and further comprising means for selecting the first WWAN antenna module type based at least on support of the 5G FR2 frequency range and further based on a use case parameter indicating 5G-GNSS positioning.

Clause 72. The wireless device of any of clauses 57 to 71, further comprising: means for transmitting antenna module capability information to a location server; and means for receiving the configuration information for the positioning process of the wireless device in accordance with the antenna module capability information.

Clause 73. The wireless device of clause 72, wherein the means for transmitting antenna module capability information comprises means for transmitting: an indication of the plurality of WWAN antenna module types included in the wireless device; a number of antenna modules having one or more of the plurality of WWAN antenna module types; a position on the wireless device of at least one of the plurality of antenna modules; orientation information for at least one of the plurality of antenna modules having at least one motorized panel with a plurality of pre-defined antenna module orientations; or a combination thereof.

Clause 74. The wireless device of clause 73, wherein the indication of WWAN antenna module type for at least a first antenna module of the plurality of antenna modules comprises an indication of 5G FR2 support for the at least the first antenna module, and wherein the means for receiving the configuration information for the positioning process comprises means for receiving configuration information for an Angle of Arrival (AoA) and Round Trip Time (RTT) cell based positioning process using the first antenna module.

Clause 75. The wireless device of any of clauses 57 to 74, wherein the wireless device includes a plurality of antenna modules having the selected WWAN antenna module type, and further comprising means for selecting one of the plurality of antenna modules having the selected WWAN antenna module type to perform at least one of the one or more positioning operations.

Clause 76. A location server, comprising: means for receiving an indication of at least a plurality of Wireless Wide Area Network (WWAN) antenna module types included in a wireless device and an indication of one or more parameters, wherein each of the plurality of WWAN antenna module types supports a Radio Access Technology (RAT) and one or more frequency ranges, and wherein the one or more parameters include one or more signal propagation parameters, one or more signal quality parameters, one or more positioning quality parameters, one or more use case parameters, or a combination thereof for antenna module selection; and means for transmitting configuration information according to a Long Term Evolution Positioning Protocol (LPP) or New Radio Positioning Protocol (NRPP) for a positioning process of the wireless device using a selected WWAN antenna module type of the plurality of WWAN antenna module types, wherein the selected WWAN antenna module type is selected based on the supported RAT, one or more frequency ranges, or a combination thereof, and further selected based on at least one of the one or more parameters.

Clause 77. The location server of clause 76, wherein the wireless device includes: at least a first antenna module with a first WWAN antenna module type supporting a fifth generation (5G) RAT and further supporting a 5G FR1 frequency range, a 5G FR2 frequency range, or both; and at least a second antenna module with a second WWAN antenna module type supporting a fourth generation (4G) RAT and further supporting a frequency range including one or more 4G frequency bands, or with a WWAN antenna module type supporting a third generation (3G) RAT and further supporting a frequency range including one or more 3G frequency bands.

Clause 78. The location server of clause 77, further comprising: means for receiving an indication that the wireless device is in communication with a 5G base station using a first subscription for a first Subscriber Identity Module (SIM) and using the first antenna module, and is further in communication with a 4G base station using a second subscription for a second SIM and using the second antenna module; and means for selecting the first WWAN antenna module type based at least on support of the 5G FR1 frequency range, the 5G FR2 frequency range, or both and further based at least on a use case parameter indicating multi-SIM use.

Clause 79. The location server of any of clauses 77 to 78, wherein the first WWAN antenna module type supports the 5G FR2 frequency range and further comprising: means for receiving an indication that the wireless device is in communication with a 5G base station using a first subscription for a first SIM and using the first antenna module, and is further in communication with a 4G base station using a second subscription for a second SIM and using the second antenna module; and means for selecting the first WWAN antenna module type based on support of the 5G FR2 frequency range and further based on the one or more signal propagation parameters indicating at least some line of sight signaling, the one or more signal quality parameters indicating a signal quality exceeding a threshold, the one or more positioning quality parameters indicating a target accuracy exceeding a threshold, the one or more positioning quality parameters indicating a target precision exceeding a threshold, the one or more use case parameters including a use case parameter associated with 5G FR2 positioning, or a combination thereof; or means for selecting the second antenna module based on the one or more signal propagation parameters indicating non line of sight signaling, the one or more signal quality parameters indicating a signal quality below a threshold, the one or more positioning quality parameters indicating a target accuracy less than a threshold, the one or more positioning quality parameters indicating a target precision less than a threshold, or a combination thereof.

Clause 80. The location server of any of clauses 77 to 79, further comprising: means for receiving an indication that the wireless device is configured to communicate with a first Radio Access Network (RAN) or a second different RAN in a network sharing system, wherein the first RAN is associated with a home Public Land Mobile Network (PLMN) operator for the wireless device that does not support 5G FR2 communications, and wherein the second different RAN is associated with a network operator that supports 5G FR2 communications; and means for selecting the first WWAN antenna module type based at least on support of the 5G FR2 frequency range and further based on a use case parameter indicating network sharing.

Clause 81. The location server of any of clauses 77 to 80, further comprising: means for receiving an indication that the wireless device is a leader device located proximate to one or more other devices included in a positioning group; and means for selecting the first WWAN antenna module type based on support of the 5G FR1 frequency range, the 5G FR2 frequency range, or both and further based at least on a use case parameter indicating the wireless device is a leader device located proximate to one or more other devices included in a positioning group.

Clause 82. The location server of any of clauses 77 to 81, wherein the positioning process is a concurrent 5G and Global Navigation Satellite System (GNSS) positioning process, and further comprising: means for receiving positioning results from the wireless device for the concurrent 5G and GNSS process, the positioning results including cellular-based positioning results using the first WWAN antenna module type selected based at least on support of the 5G FR2 frequency range and further based on a use case parameter indicating 5G-GNSS positioning.

Clause 83. The location server of any of clauses 76 to 82, further comprising: means for receiving antenna module capability information for the wireless device, wherein the wireless device includes a plurality of antenna modules and comprises a cellular modem included in a mobile phone, a cellular modem included in a vehicle, a cellular modem included in a Customer Premises Equipment (CPE), or a cellular modem included in a computing device, and wherein the antenna module capability information for the wireless device comprises: an indication of the plurality of WWAN antenna module types included in the wireless device, including an indication of a supported RAT, one or more supported frequency ranges, or a combination thereof; a number of the plurality of antenna modules having at least a first WWAN antenna module type; a position on the wireless device of at least one of the plurality of antenna modules; orientation information for at least one of the plurality of antenna modules having at least one motorized panel with a plurality of pre-defined antenna module orientations; or a combination thereof.

Clause 84. The location server of clause 83, wherein the antenna module capability information indicates the wireless device includes at least a first antenna module having 5G FR2 support, and wherein the means for transmitting the configuration information for the positioning process of the wireless device using the selected WWAN antenna module type of the plurality of WWAN antenna module types comprises means for transmitting configuration information for the wireless device to perform Angle of Arrival (AoA) and Round Trip Time (RTT) cell based positioning process using the first antenna module.

Clause 85. A non-transitory computer-readable medium storing computer-executable instructions that, when executed by a wireless device, cause the wireless device to: receive configuration information for a positioning process of the wireless device, wherein the positioning process uses a selected Wireless Wide Area Network (WWAN) antenna module type of a plurality of WWAN antenna module types each supporting a Radio Access Technology (RAT) and one or more frequency ranges, wherein the selected WWAN antenna module type is selected based on the supported RAT, one or more frequency ranges, or a combination thereof, and further selected based on one or more parameters, the one or more parameters including one or more signal propagation parameters, one or more signal quality parameters, one or more positioning quality parameters, one or more use case parameters, or a combination thereof; and perform one or more positioning operations of the positioning process using an antenna module having the selected WWAN antenna module type.

Clause 86. The non-transitory computer-readable medium of clause 85, wherein the WWAN antenna module type is selected based on selecting the positioning process using a supported RAT of the WWAN antenna module type, a frequency range supported by the WWAN antenna module type, or a combination thereof, and further selected based on at least a use case parameter.

Clause 87. The non-transitory computer-readable medium of any of clauses 85 to 86, further comprising computer-executable instructions that, when executed by the wireless device, cause the wireless device to: transmit an indication of at least the supported RAT and one or more supported frequency ranges of each WWAN antenna module type of the wireless device and an indication of the one or more signal propagation parameters, one or more signal quality parameters, one or more positioning quality parameters, one or more use case parameters, or a combination thereof to a location server for selection of the selected WWAN antenna module type.

Clause 88. The non-transitory computer-readable medium of any of clauses 85 to 87, wherein the plurality of antenna modules comprises: at least a first antenna module with a first WWAN antenna module type supporting a fifth generation (5G) RAT and further supporting a 5G FR1 frequency range, a 5G FR2 frequency range, or both; and at least a second antenna module with a second WWAN antenna module type supporting a fourth generation (4G) RAT and further supporting a frequency range including one or more 4G frequency bands, or with a second WWAN antenna module type supporting a third generation (3G) RAT and further supporting a frequency range including one or more 3G frequency bands.

Clause 89. The non-transitory computer-readable medium of clause 88, wherein in response to the wireless device being in communication with a 5G base station using a first subscription for a first Subscriber Identity Module (SIM) and using the first antenna module, and further in communication with a 4G base station using a second subscription for a second SIM and using the second antenna module, the computer-executable instructions that, when executed by the wireless device, cause the wireless device to: select the first antenna module having the first WWAN antenna module type for the positioning process based at least on support of the 5G FR1 frequency range, the 5G FR2 frequency range, or both and further based at least on a use case parameter indicating multi-SIM use.

Clause 90. The non-transitory computer-readable medium of clause 89, wherein the computer executable instructions that, when executed by the wireless device, further cause the wireless device to: select the first antenna module having the first WWAN antenna module type based on support of the 5G FR2 frequency range and further based on at least one of the one or more signal propagation parameters indicating line of sight signaling, at least one of the one or more signal quality parameters indicating a signal quality exceeding a threshold, at least one of the one or more positioning quality parameters indicating a target accuracy exceeding a threshold, at least one of the one or more positioning quality parameters indicating a target precision exceeding a threshold, a use case parameter associated with 5G FR2 positioning, or a combination thereof.

Clause 91. The non-transitory computer-readable medium of any of clauses 88 to 90, wherein in response to the wireless device being in communication with a 5G base station using a first subscription for a first SIM and using the first antenna module, and further in communication with a 4G base station using a second subscription for a second SIM and using the second antenna module, the computer-executable instructions that, when executed by the wireless device, further cause the wireless device to: transmit an indication of the one or more signal propagation parameters, the one or more signal quality parameters, the one or more positioning quality parameters, the one or more use case parameters, or the combination thereof, and wherein the configuration information comprises configuration of a positioning session using the first antenna module, assistance information to perform the one or more positioning operations using the first antenna module, or a combination thereof.

Clause 92. The non-transitory computer-readable medium of clause 91, wherein the first subscription and the second subscription are both associated with a same WWAN service provider.

Clause 93. The non-transitory computer-readable medium of any of clauses 88 to 92, wherein the wireless device is configured to communicate with a first Radio Access Network (RAN) or a second different RAN in a network sharing system.

Clause 94. The non-transitory computer-readable medium of clause 93, wherein the first RAN is associated with a home Public Land Mobile Network (PLMN) operator that does not support 5G FR2 communications, and wherein the second different RAN is associated with a network operator that supports 5G FR2 communications, and wherein the computable executable instructions further cause the wireless device to: select the first WWAN antenna module type based at least on support of the 5G FR2 frequency range and further based on a use case parameter indicating network sharing.

Clause 95. The non-transitory computer-readable medium of clause 94, wherein the computer-executable instructions that, when executed by the wireless device, cause the wireless device to select the first WWAN antenna module type based on at least one of the or more signal propagation parameters indicating at least some line of sight signaling, at least one of the one or more signal quality parameters indicating a signal quality exceeding a threshold, at least one of the one or more positioning quality parameters indicating a target accuracy exceeding a threshold, at least one of the one or more positioning quality parameters indicating a target precision exceeding a threshold, at least one of the one or more use case parameters comprise computer-executable instructions that, when executed by the wireless device, cause the wireless device to a use case parameter associated with 5G FR2 positioning, or a combination thereof.

Clause 96. The non-transitory computer-readable medium of any of clauses 88 to 95, further comprising computer-executable instructions that, when executed by the wireless device, cause the wireless device to: select the first WWAN antenna module type based on support of the 5G FR1 frequency range, the 5G FR2 frequency range, or both and further based at least on a use case parameter indicating the wireless device is a leader device located proximate to one or more other devices included in a positioning group; perform one or more cellular-based positioning operations using the first antenna module; and share estimated position information for the positioning group.

Clause 97. The non-transitory computer-readable medium of clause 96, wherein the computer-executable instructions that, when executed by the wireless device, cause the wireless device to share the estimated position information for the positioning group comprise computer-executable instructions that, when executed by the wireless device, cause the wireless device to: transmit the estimated position information to the one or more other devices included in the positioning group using device-to-device communication, transmitting the estimated position information to a location server; or a combination thereof.

Clause 98. The non-transitory computer-readable medium of any of clauses 96 to 97, wherein the wireless device comprises a cellular modem included in a mobile phone or a cellular modem included in a vehicle, and wherein the one or more other devices include at least one asset tracker.

Clause 99. The non-transitory computer-readable medium of any of clauses 88 to 98, wherein the positioning process is a concurrent 5G and Global Navigation Satellite System (GNSS) positioning process, and further comprising computer-executable instructions that, when executed by the wireless device, cause the wireless device to select the first WWAN antenna module type based at least on support of the 5G FR2 frequency range and further based on a use case parameter indicating 5G-GNSS positioning.

Clause 100. The non-transitory computer-readable medium of any of clauses 85 to 99, further comprising computer-executable instructions that, when executed by the wireless device, cause the wireless device to: transmit antenna module capability information to a location server; and receive the configuration information for the positioning process of the wireless device in accordance with the antenna module capability information.

Clause 101. The non-transitory computer-readable medium of clause 100, wherein the antenna module capability information comprises: an indication of the plurality of WWAN antenna module types included in the wireless device; a number of antenna modules having one or more of the plurality of WWAN antenna module types; a position on the wireless device of at least one of the plurality of antenna modules; orientation information for at least one of the plurality of antenna modules having at least one motorized panel with a plurality of pre-defined antenna module orientations; or a combination thereof.

Clause 102. The non-transitory computer-readable medium of clause 101, wherein the indication of WWAN antenna module type for at least a first antenna module of the plurality of antenna modules comprises an indication of 5G FR2 support for the at least the first antenna module, and wherein the computer-executable instructions that, when executed by the wireless device, cause the wireless device to receive the configuration information for the positioning process comprises computer executable instructions that cause the wireless device to receive configuration information for an Angle of Arrival (AoA) and Round Trip Time (RTT) cell based positioning process using the first antenna module.

Clause 103. The non-transitory computer-readable medium of any of clauses 85 to 102, wherein the wireless device includes a plurality of antenna modules having the selected WWAN antenna module type, and further comprising computer-executable instructions that, when executed by the wireless device, cause the location server to select one of the plurality of antenna modules having the selected WWAN antenna module type to perform at least one of the one or more positioning operations.

Clause 104. A non-transitory computer-readable medium storing computer-executable instructions that, when executed by a location server, cause the location server to: receive an indication of at least a plurality of Wireless Wide Area Network (WWAN) antenna module types included in a wireless device and an indication of one or more parameters, wherein each of the plurality of WWAN antenna module types supports a Radio Access Technology (RAT) and one or more frequency ranges, and wherein the one or more parameters include one or more signal propagation parameters, one or more signal quality parameters, one or more positioning quality parameters, one or more use case parameters, or a combination thereof for antenna module selection; and transmit configuration information according to a Long Term Evolution Positioning Protocol (LPP) or New Radio Positioning Protocol (NRPP) for a positioning process of the wireless device using a selected WWAN antenna module type of the plurality of WWAN antenna module types, wherein the selected WWAN antenna module type is selected based on the supported RAT, one or more frequency ranges, or a combination thereof, and further selected based on at least one of the one or more parameters.

Clause 105. The non-transitory computer-readable medium of clause 104, wherein the wireless device includes: at least a first antenna module with a first WWAN antenna module type supporting a fifth generation (5G) RAT and further supporting a 5G FR1 frequency range, a 5G FR2 frequency range, or both; and at least a second antenna module with a second WWAN antenna module type supporting a fourth generation (4G) RAT and further supporting a frequency range including one or more 4G frequency bands, or with a WWAN antenna module type supporting a third generation (3G) RAT and further supporting a frequency range including one or more 3G frequency bands.

Clause 106. The non-transitory computer-readable medium of clause 105, further comprising computer-executable instructions that, when executed by the location server, cause the location server to: receive an indication that the wireless device is in communication with a 5G base station using a first subscription for a first Subscriber Identity Module (SIM) and using the first antenna module, and is further in communication with a 4G base station using a second subscription for a second SIM and using the second antenna module; and select the first WWAN antenna module type based at least on support of the 5G FR1 frequency range, the 5G FR2 frequency range, or both and further based at least on a use case parameter indicating multi-SIM use.

Clause 107. The non-transitory computer-readable medium of any of clauses 105 to 106, wherein the first WWAN antenna module type supports the 5G FR2 frequency range and further comprising computer-executable instructions that, when executed by the location server, cause the location server to: receive an indication that the wireless device is in communication with a 5G base station using a first subscription for a first SIM and using the first antenna module, and is further in communication with a 4G base station using a second subscription for a second SIM and using the second antenna module; select the first WWAN antenna module type based on support of the 5G FR2 frequency range and further based on the one or more signal propagation parameters indicating at least some line of sight signaling, the one or more signal quality parameters indicating a signal quality exceeding a threshold, the one or more positioning quality parameters indicating a target accuracy exceeding a threshold, the one or more positioning quality parameters indicating a target precision exceeding a threshold, the one or more use case parameters including a use case parameter associated with 5G FR2 positioning, or a combination thereof; or select the second antenna module based on the one or more signal propagation parameters indicating non line of sight signaling, the one or more signal quality parameters indicating a signal quality below a threshold, the one or more positioning quality parameters indicating a target accuracy less than a threshold, the one or more positioning quality parameters indicating a target precision less than a threshold, or a combination thereof.

Clause 108. The non-transitory computer-readable medium of any of clauses 105 to 107, further comprising computer-executable instructions that, when executed by the location server, cause the location server to: receive an indication that the wireless device is configured to communicate with a first Radio Access Network (RAN) or a second different RAN in a network sharing system, wherein the first RAN is associated with a home Public Land Mobile Network (PLMN) operator for the wireless device that does not support 5G FR2 communications, and wherein the second different RAN is associated with a network operator that supports 5G FR2 communications, and further comprising: select the first WWAN antenna module type based at least on support of the 5G FR2 frequency range and further based on a use case parameter indicating network sharing.

Clause 109. The non-transitory computer-readable medium of any of clauses 105 to 108, further comprising computer-executable instructions that, when executed by the location server, cause the location server to: receive an indication that the wireless device is a leader device located proximate to one or more other devices included in a positioning group; and select the first WWAN antenna module type based on support of the 5G FR1 frequency range, the 5G FR2 frequency range, or both and further based at least on a use case parameter indicating the wireless device is a leader device located proximate to one or more other devices included in a positioning group.

Clause 110. The non-transitory computer-readable medium of any of clauses 105 to 109, wherein the positioning process is a concurrent 5G and Global Navigation Satellite System (GNSS) positioning process, and further comprising: receive positioning results from the wireless device for the concurrent 5G and GNSS process, the positioning results including cellular-based positioning results using the first WWAN antenna module type selected based at least on support of the 5G FR2 frequency range and further based on a use case parameter indicating 5G-GNSS positioning.

Clause 111. The non-transitory computer-readable medium of any of clauses 104 to 110, wherein the wireless device includes a plurality of antenna modules and comprises a cellular modem included in a mobile phone, a cellular modem included in a vehicle, a cellular modem included in a Customer Premises Equipment (CPE), or a cellular modem included in a computing device, and further comprising computer-executable instructions that, when executed by the location server, cause the location server to: receive antenna module capability information for the wireless device, wherein the antenna module capability information for the wireless device comprises: an indication of the plurality of WWAN antenna module types included in the wireless device, including an indication of a supported RAT, one or more supported frequency ranges, or a combination thereof; a number of the plurality of antenna modules having at least a first WWAN antenna module type; a position on the wireless device of at least one of the plurality of antenna modules; orientation information for at least one of the plurality of antenna modules having at least one motorized panel with a plurality of pre-defined antenna module orientations; or a combination thereof.

Clause 112. The non-transitory computer-readable medium of clause 111, wherein the antenna module capability information indicates the wireless device includes at least a first antenna module having 5G FR2 support, and wherein the computer-executable instructions that, when executed by the wireless device, cause the wireless device to transmit the configuration information for the positioning process of the wireless device using the selected WWAN antenna module type of the plurality of WWAN antenna module types comprises comprise computer-executable instructions that cause the wireless device to transmit configuration information for the wireless device to perform Angle of Arrival (AoA) and Round Trip Time (RTT) cell based positioning process using the first antenna module.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A wireless device, comprising:
one or more memories;
one or more transceivers;
a plurality of antenna modules; and
one or more processors communicatively coupled to the one or more memories and the one or more transceivers, the one or more processors, either alone or in combination, being configured to:
receive, via the one or more transceivers, configuration information for a positioning process of the wireless device, wherein the positioning process uses a selected Wireless Wide Area Network (WWAN) antenna module type of a plurality of WWAN antenna module types each supporting a Radio Access Technology (RAT) and one or more frequency ranges, wherein the selected WWAN antenna module type is selected based on the supported RAT, one or more frequency ranges, or a combination thereof, and further selected based on one or more parameters, the one or more parameters including one or more signal propagation parameters, one or more signal quality parameters, one or more positioning quality parameters, one or more use case parameters, or a combination thereof; and
perform one or more positioning operations of the positioning process using an antenna module having the selected WWAN antenna module type.

2. The wireless device of claim 1, wherein the WWAN antenna module type is selected based on selecting the positioning process using a supported RAT of the WWAN antenna module type, a frequency range supported by the WWAN antenna module type, or a combination thereof, and is further selected based on at least a use case parameter.

3. The wireless device of claim 1, wherein the one or more processors, either alone or in combination, are further configured to:
transmit, via the one or more transceivers, an indication of at least the supported RAT and one or more supported frequency ranges of each of the plurality of WWAN antenna module types of the wireless device and an indication of the one or more signal propagation parameters, one or more signal quality parameters, one or more positioning quality parameters, one or more use case parameters, or a combination thereof to a location server for selection of the selected WWAN antenna module type.

4. The wireless device of claim 1, wherein the plurality of antenna modules comprises:
at least a first antenna module with a first WWAN antenna module type supporting a fifth generation (5G) RAT and further supporting a 5G FR1 frequency range, a 5G FR2 frequency range, or both; and
at least a second antenna module with a second WWAN antenna module type supporting a fourth generation (4G) RAT and further supporting a frequency range including one or more 4G frequency bands, or with a second WWAN antenna module type supporting a third generation (3G) RAT and further supporting a frequency range including one or more 3G frequency bands.

5. The wireless device of claim 4, wherein in response to the wireless device being in communication with a 5G base station using a first subscription for a first Subscriber Identity Module (SIM) and using the first antenna module, and further in communication with a 4G base station using a second subscription for a second SIM and using the second antenna module, the one or more processors, either alone or in combination, are further configured to:
select the first antenna module having the first WWAN antenna module type for the positioning process based at least on support of the 5G FR1 frequency range, the 5G FR2 frequency range, or both and further based at least on a use case parameter indicating multi-SIM use.

6. The wireless device of claim 5, wherein the one or more processors, either alone or in combination, are further configured to select the first antenna module having the first WWAN antenna module type based on support of the 5G FR2 frequency range and further based on at least one of the one or more signal propagation parameters indicating line of sight signaling, at least one of the one or more signal quality parameters indicating a signal quality exceeding a threshold, at least one of the one or more positioning quality parameters indicating a target accuracy exceeding a threshold, at least one of the one or more positioning quality parameters indicating a target precision exceeding a threshold, a use case parameter associated with 5G FR2 positioning, or a combination thereof.

7. The wireless device of claim 4, wherein in response to the wireless device being in communication with a 5G base station using a first subscription for a first SIM and using the first antenna module, and further in communication with a 4G base station using a second subscription for a second SIM and using the second antenna module, the one or more processors, either alone or in combination, are further configured to:
transmit, via the one or more transceivers, an indication of the one or more signal propagation parameters, the one or more signal quality parameters, the one or more positioning quality parameters, the one or more use case parameters, or the combination thereof, and wherein the configuration information comprises configuration of a positioning session using the first antenna module, assistance information to perform the one or more positioning operations using the first antenna module, or a combination thereof.

8. The wireless device of claim 7, wherein the first subscription and the second subscription are both associated with a same WWAN service provider.

9. The wireless device of claim 4, wherein the wireless device is configured to communicate with a first Radio Access Network (RAN) or a second different RAN in a network sharing system.

10. The wireless device of claim 9, wherein the first RAN is associated with a home Public Land Mobile Network (PLMN) operator that does not support 5G FR2 communications, and wherein the second different RAN is associated with a network operator that supports 5G FR2 communications, and wherein the one or more processors, either alone or in combination, are further configured to:
select the first WWAN antenna module type based at least on support of the 5G FR2 frequency range and further based on a use case parameter indicating network sharing.

11. The wireless device of claim 10, wherein the one or more processors, either alone or in combination, are further configured to select the first WWAN antenna module type based on at least one of the or more signal propagation parameters indicating at least some line of sight signaling, at least one of the one or more signal quality parameters indicating a signal quality exceeding a threshold, at least one of the one or more positioning quality parameters indicating a target accuracy exceeding a threshold, at least one of the one or more positioning quality parameters indicating a target precision exceeding a threshold, at least one of the one or more use case parameters, the one or more processors, either alone or in combination, are configured to a use case parameter associated with 5G FR2 positioning, or a combination thereof.

12. The wireless device of claim 4, wherein the one or more processors, either alone or in combination, are further configured to:
select the first WWAN antenna module type based on support of the 5G FR1 frequency range, the 5G FR2 frequency range, or both and further based at least on a use case parameter indicating the wireless device is a leader device located proximate to one or more other devices included in a positioning group;
perform one or more cellular-based positioning operations using the first antenna module; and
share estimated position information for the positioning group.

13. The wireless device of claim 12, wherein, to share the estimated position information for the positioning group, the one or more processors, either alone or in combination, are configured to:
transmit, via the one or more transceivers, the estimated position information to the one or more other devices included in the positioning group using device-to-device communication, transmitting the estimated position information to a location server; or a combination thereof.

14. The wireless device of claim 12, wherein the wireless device comprises a cellular modem included in a mobile phone or a cellular modem included in a vehicle, and wherein the one or more other devices include at least one asset tracker.

15. The wireless device of claim 4, wherein the positioning process is a concurrent 5G and Global Navigation Satellite System (GNSS) positioning process, and wherein the one or more processors, either alone or in combination, are further configured to select the first WWAN antenna module type based at least on support of the 5G FR2 frequency range and further based on a use case parameter indicating 5G-GNSS positioning.

16. The wireless device of claim 1, wherein the one or more processors, either alone or in combination, are further configured to:
transmit, via the one or more transceivers, antenna module capability information to a location server; and
receive, via the one or more transceivers, the configuration information for the positioning process of the wireless device in accordance with the antenna module capability information.

17. The wireless device of claim 16, wherein the antenna module capability information comprises:
an indication of the plurality of WWAN antenna module types included in the wireless device;
a number of antenna modules having one or more of the plurality of WWAN antenna module types;
a position on the wireless device of at least one of the plurality of antenna modules;
orientation information for at least one of the plurality of antenna modules having at least one motorized panel with a plurality of pre-defined antenna module orientations; or
a combination thereof.

18. The wireless device of claim 17, wherein the indication of WWAN antenna module type for at least a first antenna module of the plurality of antenna modules comprises an indication of 5G FR2 support for the at least the first antenna module, and wherein the configuration information for the positioning process comprises configuration information for an Angle of Arrival (AoA) and Round Trip Time (RTT) cell based positioning process using the first antenna module.

19. The wireless device of claim 1, wherein the wireless device includes a plurality of antenna modules having the selected WWAN antenna module type, and wherein the one or more processors, either alone or in combination, are further configured to select one of the plurality of antenna modules having the selected WWAN antenna module type to perform at least one of the one or more positioning operations.

20. A location server, comprising:
one or more memories;
one or more transceivers; and
one or more processors communicatively coupled to the one or more memories and the one or more transceivers, the one or more processors, either alone or in combination, being configured to:
receive, via the one or more transceivers, an indication of at least a plurality of Wireless Wide Area Network (WWAN) antenna module types included in a wireless device and an indication of one or more parameters, wherein each of the plurality of WWAN antenna module types supports a Radio Access Technology (RAT) and one or more frequency ranges, and wherein the one or more parameters include one or more signal propagation parameters, one or more signal quality parameters, one or more positioning quality parameters, one or more use case parameters, or a combination thereof for antenna module selection; and
transmit, via the one or more transceivers and according to a Long Term Evolution Positioning Protocol (LPP) or New Radio Positioning Protocol (NRPP), configuration information for a positioning process of the wireless device using a selected WWAN antenna module type of the plurality of WWAN antenna module types, wherein the selected WWAN antenna module type is selected based on the supported RAT, one or more frequency ranges, or a combination thereof, and further selected based on at least one of the one or more parameters.

21. The location server of claim 20, wherein the wireless device includes:
at least a first antenna module with a first WWAN antenna module type supporting a fifth generation (5G) RAT and further supporting a 5G FR1 frequency range, a 5G FR2 frequency range, or both; and
at least a second antenna module with a second WWAN antenna module type supporting a fourth generation (4G) RAT and further supporting a frequency range including one or more 4G frequency bands, or with a WWAN antenna module type supporting a third generation (3G) RAT and further supporting a frequency range including one or more 3G frequency bands.

22. The location server of claim 21, wherein the one or more processors, either alone or in combination, are further configured to:
receive, via the one or more transceivers, an indication that the wireless device is in communication with a 5G base station using a first subscription for a first Subscriber Identity Module (SIM) and using the first antenna module, and is further in communication with a 4G base station using a second subscription for a second SIM and using the second antenna module; and
select the first WWAN antenna module type based at least on support of the 5G FR1 frequency range, the 5G FR2 frequency range, or both and further based at least on a use case parameter indicating multi-SIM use.

23. The location server of claim 21, wherein the first WWAN antenna module type supports the 5G FR2 frequency range and wherein the one or more processors, either alone or in combination, are further configured to:
receive, via the one or more transceivers, an indication that the wireless device is in communication with a 5G base station using a first subscription for a first SIM and using the first antenna module, and is further in communication with a 4G base station using a second subscription for a second SIM and using the second antenna module; and
select the first WWAN antenna module type based on support of the 5G FR2 frequency range and further based on the one or more signal propagation parameters indicating at least some line of sight signaling, the one or more signal quality parameters indicating a signal quality exceeding a threshold, the one or more positioning quality parameters indicating a target accuracy exceeding a threshold, the one or more positioning quality parameters indicating a target precision exceeding a threshold, the one or more use case parameters including a use case parameter associated with 5G FR2 positioning, or a combination thereof; or
select the second antenna module based on the one or more signal propagation parameters indicating non line of sight signaling, the one or more signal quality parameters indicating a signal quality below a threshold, the one or more positioning quality parameters indicating a target accuracy less than a threshold, the one or more positioning quality parameters indicating a target precision less than a threshold, or a combination thereof.

24. The location server of claim 21, wherein the one or more processors, either alone or in combination, are further configured to:
receive, via the one or more transceivers, an indication that the wireless device is configured to communicate with a first Radio Access Network (RAN) or a second different RAN in a network sharing system, wherein the first RAN is associated with a home Public Land Mobile Network (PLMN) operator for the wireless device that does not support 5G FR2 communications, and wherein the second different RAN is associated with a network operator that supports 5G FR2 communications; and
select the first WWAN antenna module type based at least on support of the 5G FR2 frequency range and further based on a use case parameter indicating network sharing.

25. The location server of claim 21, wherein the one or more processors, either alone or in combination, are further configured to:
receive, via the one or more transceivers, an indication that the wireless device is a leader device located proximate to one or more other devices included in a positioning group; and
select the first WWAN antenna module type based on support of the 5G FR1 frequency range, the 5G FR2 frequency range, or both and further based at least on a use case parameter indicating the wireless device is a leader device located proximate to one or more other devices included in a positioning group.

26. The location server of claim 21, wherein the positioning process is a concurrent 5G and Global Navigation Satellite System (GNSS) positioning process, and wherein the one or more processors, either alone or in combination, are further configured to:
receive, via the one or more transceivers, positioning results from the wireless device for the concurrent 5G and GNSS process, the positioning results including cellular-based positioning results using the first WWAN antenna module type selected based at least on support of the 5G FR2 frequency range and further based on a use case parameter indicating 5G-GNSS positioning.

27. The location server of claim 20, wherein the wireless device includes a plurality of antenna modules and comprises a cellular modem included in a mobile phone, a cellular modem included in a vehicle, a cellular modem included in a Customer Premises Equipment (CPE), or a cellular modem included in a computing device, and wherein the one or more processors, either alone or in combination, are further configured to receive, via the one or more transceivers, antenna module capability information for the wireless device, and wherein the antenna module capability information for the wireless device comprises:
an indication of the plurality of WWAN antenna module types included in the wireless device, including an indication of a supported RAT, one or more supported frequency ranges, or a combination thereof;
a number of the plurality of antenna modules having at least a first WWAN antenna module type;
a position on the wireless device of at least one of the plurality of antenna modules;
orientation information for at least one of the plurality of antenna modules having at least one motorized panel with a plurality of pre-defined antenna module orientations; or
a combination thereof.

28. The location server of claim 27, wherein the antenna module capability information indicates the wireless device includes at least a first antenna module having 5G FR2 support, and wherein the one or more processors, either alone or in combination, are further configured to:
transmit the configuration information for the positioning process of the wireless device using the selected WWAN antenna module type of the plurality of WWAN antenna module types comprises transmitting configuration information for the wireless device to perform Angle of Arrival (AoA) and Round Trip Time (RTT) cell based positioning process using the first antenna module.

29. A method of positioning performed by a wireless device including a plurality of antenna modules, comprising:
receiving configuration information for a positioning process of the wireless device, wherein the positioning process uses a selected Wireless Wide Area Network (WWAN) antenna module type of a plurality of WWAN antenna module types each supporting a Radio Access Technology (RAT) and one or more frequency ranges, wherein the selected WWAN antenna module type is selected based on the supported RAT, one or more frequency ranges, or a combination thereof, and further selected based on one or more parameters, the one or more parameters including one or more signal propagation parameters, one or more signal quality parameters, one or more positioning quality parameters, one or more use case parameters, or a combination thereof; and
performing one or more positioning operations of the positioning process using an antenna module having the selected WWAN antenna module type.

30. A method performed at a location server, comprising:
receiving an indication of at least a plurality of Wireless Wide Area Network (WWAN) antenna module types included in a wireless device and an indication of one or more parameters, wherein each of the plurality of WWAN antenna module types supports a Radio Access Technology (RAT) and one or more frequency ranges, and wherein the one or more parameters include one or more signal propagation parameters, one or more signal quality parameters, one or more positioning quality parameters, one or more use case parameters, or a combination thereof for antenna module selection; and
transmitting configuration information according to a Long Term Evolution Positioning Protocol (LPP) or New Radio Positioning Protocol (NRPP) for a positioning process of the wireless device using a selected WWAN antenna module type of the plurality of WWAN antenna module types, wherein the selected WWAN antenna module type is selected based on the supported RAT, one or more frequency ranges, or a combination thereof, and further selected based on at least one of the one or more parameters.
